(19) United States
(12) Patent Application Publication
(10) Pub. No.: US 2014/0316940 A1
(43) Pub. Date: Oct. 23, 2014

(54) METHOD, APPARATUS, AND COMPUTER PROGRAM PRODUCT FOR DETERMINING PARTICIPANT RATINGS

(71) Applicant: APTITUDE, LLC, Irving, TX (US)

(72) Inventors: Troy Wayne Kirchenbauer, Hurst, TX (US); Patrick Richer, Dallas, TX (US); Russell Francis Lewis, Dallas, TX (US)

(73) Assignee: Aptitude, LLC, Irving, TX (US)

(21) Appl. No.: 13/867,035

(22) Filed: Apr. 20, 2013

(51) Int. Cl. G06Q 30/06

(52) U.S. Cl. CPC G06Q 30/0609
USPC 705/26.35

(57) ABSTRACT

Some examples provide systems, methods, apparatus, and computer program products for evaluating participants in a market platform based on the performance of the participants in transactions using the market platform. These evaluations may result in ratings being assigned to the participants, where the rating provides an assessment of the desirability of contracting with the particular party. For example, a rating may provide an estimate of the likelihood that a buyer will comply with the commitment level of their committed pricing agreement, or a rating may provide an estimate of how likely a supplier is to deliver ordered goods in a timely manner and at an agreed-upon price. Implementations may further allow for configuration of a rating engine to provide a unique rating designed for a particular contracting party.

### TECHNOLOGICAL FIELD

Example embodiments of the present invention relate generally to computer-provided services and, more particularly, to systems, methods, apparatuses, and computer program products for a market platform.

### BACKGROUND

Advances in information technology have revolutionized some product supply chains. So-called enterprise resource planning (ERP) systems provide users with the capability to link various elements of product/service supply chains by providing a single data repository of manufacturing, accounting, sales, and customer relationship management. However, these systems are typically only useful for supply chains with defined, predictable, product sourcing arrangements. For example, such systems may be optimized for scenarios in which a buyer contracts to buy a defined number of products, and the buyer receives a discount based on the volume of their order.

In some industries, buyers are unable to plan their supply needs in advance with any particular level of certainty. For example, healthcare organizations (HCOs) typically run through particular medical supplies as they receive patients that require those supplies. It can be difficult, if not impossible, to predict the volume of such supplies that will be needed, as that would also require accurate prediction of which patients will get sick, in what way, and when. Additionally, some functionally equivalent products may have equivalents supplied by multiple suppliers. For example, latex surgical gloves may be marketed by several different suppliers under different brand names, even though the product is interchangeable across suppliers. One way that HCOs and other buyers with highly variable product needs have addressed the unpredictability of sales volume and the interchangeability of the products is to receive market-share based pricing from suppliers. For example, while the buyer may not be able to guarantee a particular volume, they may be able to guarantee that they will purchase 80% of products within a particular group of products from a particular supplier. In exchange, the supplier may offer the buyer a particular discount as long as the buyer meets their commitment to buy 80% of the products within the particular group of products from that particular supplier. For the purposes of this application, the term “products” is intended to have broad meaning, including but not limited to tangible and intangible goods both within and outside of the healthcare domain. Examples of these products may include medical supplies and devices, physician preference items, pharmaceuticals, capital, services, and the like.

Although this contracting method may help to ensure fairer pricing for the buyer without the need to commit to a particular purchase volume, monitoring compliance for such market-share based pricing and contracts is difficult, as it is up to the supplier to enforce the pricing even though the supplier may not have enough data to ensure compliance (e.g., each supplier knows the number of products purchased by the buyer from the supplier, but not how many products, including functionally equivalent products within the category were purchased by the buyer across all suppliers). Buyers have little incentive to inform suppliers when the buyer fails to meet its market share purchase commitments (as this would often trigger a higher cost or other penalty), but there are no other parties who are in a better position to determine whether such commitments are being met. Since compliance is difficult, if not impossible, to monitor and enforce, suppliers must build the cost of non-compliance and potential non-compliance into their offered contract price, often resulting in the supplier not offering the most competitive price possible. Suppliers may also wish to offer their buyers alternative contracting models based on the particular needs of the buyer, but enforcement of such alternative contracting models is difficult, if not impossible, with the current state of the art.

Furthermore, buyers may have a difficult time determining which contract offers to accept from sellers' response to a request for pricing (RFP), as particular suppliers may offer disparate pricing within product categories. For example, a buyer may lower costs in aggregate by agreeing to a particular contract to obtain a larger discount on a first, high volume product, even if the contract requires a high price for a second, low volume product. Without the ability to compare aggregate costs across products in a category or across categories, the buyer might be inclined to accept an alternative contract that provides a lower price on the second, low volume product, but less or no discount on the first, high volume product. Suppliers may also provide different coverage across a given group of products, and it may be difficult to compare pricing responses received from different suppliers.

Suppliers also often devote resources to determining particular prices and discount levels for buyers based on characteristics of the buyer. In determining these prices, suppliers may account for the anticipated spend based on prior purchasing history of the buyer, the discount percentage the supplier can offer while still making a reasonable profit, the expected duration of the contract, whether the contract offers fixed, variable, or another type of pricing, market share commitment levels offered by the buyer, the duration of the contract and other contract provisions. Since these characteristics may vary from buyer to buyer and contract to contract with the same buyer, suppliers often spend a significant amount of time tailoring their contract offers to the needs and characteristics of the particular buyer for a particular group of products. Adjustment of pricing levels as different characteristics change during the negotiation process (e.g., the buyer expresses a desire for a longer term contract, resulting in an adjustment to a price discount) is typically performed manually. Adjusting prices in this manner may lead to subjective price discount levels and an obfuscated negotiation process, resulting in unpredictable results for both suppliers and buyers, as well as a lengthy and laborious negotiation process for both buyers and suppliers.

Additionally, parties to a particular contract may be unaware of a particular risk associated with contracting with a particular contracting party. For example, buyers may not meet previously-agreed-upon commitment levels, or suppliers may be subject to frequent backorders or product recalls. Buyers may frequently initiate RFPs but rarely follow through on responses received from suppliers, resulting in wasted effort by suppliers in preparing the responses. As such, participants (e.g., buyers, suppliers, and/or distributors), may make assumptions or best guesses based on limited information to account for possible risks in entering into contracts with other parties. These assumptions and guesses may result in overestimation or underestimation of the risks and benefits for contracting with particular parties, causing inefficient decision-making and/or contracting terms that are not optimized for the circumstances of the particular parties.

Therefore, a need exists for a market platform that determines ratings for participants to assist with the contracting process.

### SUMMARY

Some example embodiments provide systems, methods, apparatus, and computer program products for providing a market platform. The market platform may operate to inform buyers and suppliers, to allow buyers and suppliers to select products and contracting parameters to meet their needs, to allow buyers and suppliers to commit to supply agreements, and to monitor compliance with and enforce those supply agreements. These embodiments may provide such an integrated system by receiving buyer spend data, generating a request for pricing, receiving contract offers from one or more suppliers based on the spend data, allowing the buyer to select one or more of the contract offers, and monitoring spend data to inform and/or enforce compliance with the selected contract offer. The system may include dynamic pricing models, altering the price of the purchased products based on compliance with the selected contract offer. The system may also allow for various contracting models for managing the pricing of products or providing other financial benefits to buyers and/or suppliers based on the contractual terms agreed to by the buyer and supplier. These financial benefits may include price discounts, rebate payments, escrow refunds, insurance premiums or benefits, or any other type of financial benefit agreed to by the buyer and supplier. The system may also provide the buyer with a plurality of contracting options across plurality of suppliers, including determining an optimal contracting mix for the buyer based on one or more criteria, such as minimizing aggregate cost, minimizing the number of suppliers, minimizing product conversions maintaining relationships with one or more preferred suppliers, or the like. In this manner, embodiments may provide a complete, closed-loop market ecosystem that benefits both buyers and suppliers.

Embodiments may further include systems, apparatuses, and computer program products for evaluating participants based on the performance of the participants in the market platform using the market platform. These evaluations may result in ratings being assigned to the participants, where the rating provides an assessment of the desirability of contracting with the particular party. For example, a rating may provide an estimate of the likelihood that a buyer will comply with the commitment level of their committed pricing agreement, or a rating may provide an estimate of how likely a supplier is to deliver ordered goods in a timely manner and at an agreed-upon price. Embodiments may further allow for configuration of a rating engine to provide a unique rating designed for a particular contracting party. For example, a particular supplier may wish to weight the total sales volume offered by a buyer more highly than the buyer's market-share commitment compliance history.

In some embodiments, ratings associated with participants may be used throughout the contracting process. For example, a supplier may identify multiple pricing models, with each pricing model associated with a particular rating value. When the supplier prepares a response to an RFP, the default pricing model used for the response may be determined based on the rating associated with the buyer that initiated the RFP. As another example, suppliers may be sorted by rating when presenting supplier responses to an RFP to a buyer, with suppliers associated with higher ratings displayed more prominently than suppliers with lower ratings.

Embodiments may include a method for providing participant ratings. The method may include receiving transaction data. The transaction data may include data related to at least one transaction performed by a first participant using a market platform. The method may also include determining, using a processor, a rating for the first participant based on the transaction data. The rating may reflect one or more characteristics relating to the first participant's compliance with the terms of a committed pricing agreement generated by the market platform. The method may also include providing the rating to a second participant to assist the second participant with performing a transaction with the first participant.

Embodiments may also include an apparatus for providing participant ratings. The apparatus may include at least one processor and at least one memory. The memory may include instructions that, when executed by a processor, configure the apparatus to receive transaction data. The transaction data may include data related to at least one transaction performed by a first participant using a market platform. The instructions may further configure the apparatus to determine a rating for the first participant based on the transaction data. The rating may reflect one or more characteristics relating to the first participant's compliance with the terms of a committed pricing agreement generated by the market platform. The instructions may also configure the apparatus to provide the rating to a second participant to assist the second participant with performing a transaction with the first participant.

Embodiments may also include a computer program product including a non-transitory computer readable storage medium. The non-transitory computer readable storage medium may include instructions that, when executed by a processor, configure the processor to receive transaction data. The transaction data may include data related to at least one transaction performed by a first participant using a market platform. The instructions may further configure the processor to determine a rating for the first participant based on the transaction data. The rating may reflect one or more characteristics relating to the first participant's compliance with the terms of a committed pricing agreement generated by the market platform. The instructions may also configure the processor to provide the rating to a second participant to assist the second participant with performing a transaction with the first participant.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 depicts a block diagram of an apparatus in accordance with some example embodiments;

FIG. 2 depicts a block diagram of a market platform in accordance with some example embodiments;

FIG. 3 depicts a flow diagram of an example method for implementing a market platform in accordance with some example embodiments;

FIG. 4 depicts a block diagram of an example committed pricing agreement in accordance with some example embodiments;

FIG. 5 depicts a flow diagram illustrating an example method for providing contract compliance monitoring in accordance with some example embodiments;

FIG. 6 depicts a flow diagram illustrating a process for providing inputs to a rating engine to derive rating data in accordance with some example embodiments;

FIG. 7 depicts a flow diagram illustrating an example method for deriving participant ratings in accordance with some example embodiments;

FIG. 8 depicts a flow diagram illustrating an example method for using supplier ratings to inform a buyer during a transaction in accordance with some example embodiments;

FIG. 9 depicts a flow diagram illustrating an example method for using buyer ratings to inform a supplier during a transaction in accordance with some example embodiments;

FIG. 10 depicts a flow diagram illustrating an example method for resolving a dispute using participant ratings in accordance with some example embodiments;

FIG. 11 depicts a flow diagram illustrating an example method for attributing a delay to a supplier or a distributor for adjusting a participant rating in accordance with some example embodiments;

FIG. 12 depicts an illustration of an interface for viewing a participant rating in accordance with some example embodiments; and

FIG. 13 depicts an illustration of another interface for viewing a participant rating in accordance with some example embodiments.

### DETAILED DESCRIPTION

Aspects of the disclosure include an integrated market platform. The market platform may provide buyers and suppliers with information about a particular market (e.g., healthcare, pharmaceuticals, construction, office supplies, etc.), allowing the buyers and suppliers to enter informed decisions regarding purchase and supply contracts. The market platform may further provide capabilities for optimization, selection, and management of these contracts. Contracts entered between buyers and suppliers may be monitored by the market platform to measure, report, and/or enforce compliance with the terms of the contracts. Example embodiments may include methods, systems, apparatuses, and computer program products for leveraging access to buyer spend data to implement a system that allows customers to select a purchase plan that most meets their needs, while also ensuring compliance with contract terms. Such a system benefits both buyer and suppliers, as buyers are offered multiple options to optimize their spending patterns, while suppliers are ensured contract compliance, allowing them to offer optimal pricing to buyers. Optimization may be based around maximizing value for the buyers and/or suppliers. The term “value” in this context should be understood to mean financial, quality, efficacy, or other qualities or characteristics which the parties may find desirable. For example, the value may relate to minimizing a total dollar cost of all purchasing, maximizing efficacy or quality of purchased products, or minimizing a transition cost resulting from a change in suppliers.

The market platform may provide for efficient pricing and management of responses to requests for pricing prepared by buyers. In this regard, the market platform may provide interfaces for establishing product prices based on various factors, such as product category, market share commitment of the buyer, contract type and duration, and the like. An interface may be provided that allows for efficient management of these different parameters to provide buyers with a variety of options to allow for efficient allocation of purchase agreements. These parameters may include both fixed parameters (e.g., contract duration) and variable parameters (e.g., buyer spend in a particular category). The market platform may include monitoring and adjustment based on both types of parameters, including applying dynamic adjustments based on variable parameters as these parameters change.

The market platform may also provide an interface for buyers to consider contract pricing proposals prepared by multiple suppliers, and to simulate the effects of various levels of market share commitment and product category allocation across the proposals prepared by the suppliers. The buyer may be provided with the capability to optimize a set of contracts from among contracts offered by the suppliers that best meet the needs of the buyer. These optimizations may include minimizing overall cost, best savings with a particular supplier, minimizing conversion from a current set of suppliers, and minimizing the number of suppliers. Product cross-reference functionality may also be provided to allow for efficient purchase planning and selection of alternative products in a particular category.

Suppliers may utilize the market platform to generate price responses for products. These price responses may be generated based on product price levels and discount terms established for different contract parameters by the supplier. For the purposes of this application, the term “contract parameters” refers to features of the contract that the supplier may wish to associate with discounts to incentivize the buyer to comply with particular parameters or engage in a particular contracted behavior. For example, the supplier may offer discounts based on contract parameters such as contract duration, market share commitment, buyer spend volume, or the like. The term “discount term” should be understood to relate to a particular discount level associated with achievement according to a particular contract parameter. For example, a discount term of “5%” might be associated with a contract duration parameter of 24 months, or a discount term of “10%” might be associated with a market share parameter of “40% market share”. These discount terms may be applied to a set of product price data to provide the buyer with a price response. In some embodiments, these discounts are provided as one of two types of discounts. A first discount type may include a discount based on a maximum and minimum product price value. For example, a set of product price data may establish a maximum price and a minimum price, and a discount percentage may represent a percentage of the spread between the two prices. A second discount type may include a maximum absolute discount value. For example, a maximum discount value may be specified as a particular maximum percentage off a list price, such as a maximum discount value of 15%. The price model may provide the buyer with information sufficient to enable the buyer to observe the impact on product prices as the contract parameters are altered by the buyer.

The market platform may further provide an interface for management of compliance with commitments between the buyer and supplier. The ability to monitor buyer spend data allows the market platform to determine the market share the buyer is providing to the supplier for the particular product or product category that is the subject of a supply contract between the buyer and supplier. The market platform may report market share compliance to both the buyer and supplier, and enforce contract provisions according to the market share commitment met by the buyer. The market platform may also allow for the buyer and supplier to agree to particular enforcement provisions, rewards, and penalties for individual contracts.

The market platform may also function to establish ratings for participants such as buyers, suppliers, and distributors. For the purposes of this application, the term “participants” should be understood to include any party who may engage in contracting, purchasing, distribution, marketing, or compliance monitoring using the market platform. For example, the term “participant” may be used to describe buyers, suppliers, distributors, manufacturers, or marketers that engage with the market platform. The ratings may be based on the participant's interactions with the market platform, such as the behavior of the participants during the RFP, contracting, and purchasing processes. These ratings may be disclosed to other participants to assist with risk management, resource allocation, and decision-making using the market platform. These ratings may be provided as a score according to a defined scoring algorithm (e.g., a single scoring algorithm for each buyer, supplier, or distributor), or by a configurable scoring process unique for a particular party (e.g., a set of weighted parameters defined by the particular party). The ratings may be employed by the participants to assist with evaluation of contracting decisions. In some implementations, the market platform may calculate and display ratings at particular decision points (e.g., when selecting suppliers for generation of an RFP, when determining a price model for preparing a response to an RFP, when entering into a committed pricing agreement, or when evaluating compliance with a committed pricing agreement) to assist and inform participants throughout the process. In some embodiments, the market platform may calculate ratings and use the calculated ratings to automatically make decisions or otherwise alter or generate input throughout the process of contracting and compliance monitoring. For example, the participants may establish certain default behavior based on the rating associated with counter-parties, such as selecting a default price model based on a buyer rating, or displaying particular suppliers based on supplier ratings.

In some embodiments, participant ratings may be used to establish risk levels and pricing for various derivative products. For example, participants may hedge risk or insure against non-compliance by creation of derivative products related to risks associated with meeting market share commitment levels. Derivative instruments may be used to allow suppliers to hedge against the risk of non-compliance by their buyers, such as by selling an instrument including multiple tranches of buyers of different risks, where payment on the instrument with the rate at which buyers associated with the instrument fail to meet market share commitments. For example, ratings may be used to automate “bundling” of contracts for financing opportunities. The market platform may collect a set of sellers that have active contracts. The market platform may use the ratings of the buyers associated with the CPAs to select “quality” low-risk contracts (e.g., contracts associated with highly rated buyers). These contracts may be bundled together and used to offer sellers financing on the contracts, such as one time, discounted payouts to purchase the low-risk contracts.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, and/or the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, an applications processor integrated circuit for an integrated circuit in a server, a network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to a transitory electromagnetic signal.

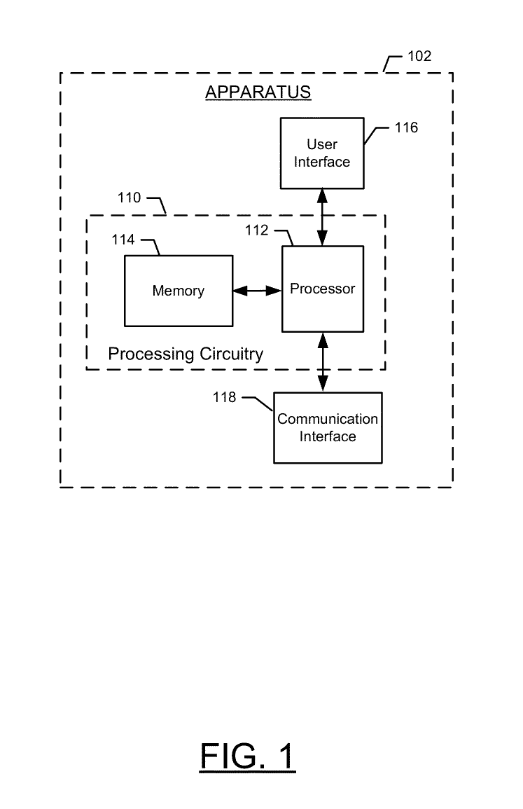

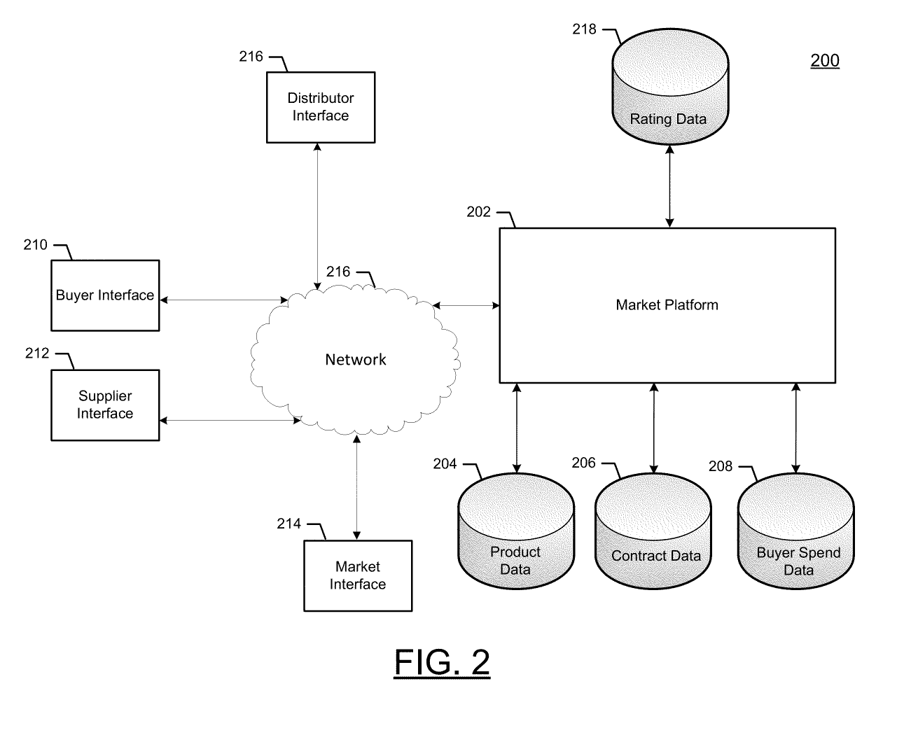

FIG. 1 illustrates a block diagram of an apparatus 102 in accordance with some example embodiments. The apparatus 102 may include a computing device that enables a market platform as described above. For example, the apparatus 102 may be implemented on one or more servers or other computing devices that may be configured to implement and control applications in accordance with various example embodiments. These applications may include hardware and software modules configured to receive market information, and to provide services related to the market platform as described above. As another example, the apparatus 102 may be implemented on one or more servers to provide a back-end interface and/or web interface in accordance with various example embodiments. Examples of computing devices that may correspond to the apparatus 102 are described further below with respect to FIG. 2. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA, or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 to carry out the functionality associated with each respective application. In some cases, the memory 114 may be in communication with one or more of the processor 112, user interface 116, and communication interface 118 via a bus(es) for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms. In embodiments in which the apparatus 102 is implemented on a server, aspects of the user interface 116 may be limited, or the user interface 116 may even be eliminated.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the Internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

FIG. 2 depicts a block diagram of a system 200 for managing purchase contracts in accordance with some example embodiments. The system 200 may include several computing nodes or devices in communication with one another. Each of the devices may have the same or similar configuration to the apparatus 102 described with respect to FIG. 1. The system 200 may include a market platform server 202 in communication with one or more of a buyer interface 210, a supplier interface 212, a market interface 214, a distributor interface 216 and/or other devices (not pictured). The market platform server 202 may send and receive data to and from these devices 210-216 to facilitate management of a supply market.

The market platform server 202 may access one or more datastores. These datastores may include a product datastore 204, a contract datastore 206, a buyer spend datastore 208, and a ratings datastore 218. By accessing these datastores 204, 206, 208, and 218, the market platform server 202 may provide information to buyers and suppliers, manage contracts, monitor compliance with said contracts, and establish ratings for market platform participants.

The product datastore 204 may include information describing products available from one or more suppliers. For example, in the medical field, HCOs may purchase tens of thousands of distinct medical and surgical supply products. These products may be purchased from hundreds or thousands of different suppliers. Such products may be organized into various categories relating to the type of product, the intended use of the product, or the like. For example, in the case of medical supplies and devices, products may be identified as belonging to a particular United Nations Standard Products and Services Code (UNSPSC). A category may be a pre-defined collection of one or more, and typically a plurality of, UNSPSCs. Categories may be pre-defined for a particular market ecosystem or may be pre-defined by the market. For example, products may be assigned to particular categories by the functionality of the product (e.g., products that protect the user from a particular hazard), by the construction of the product (e.g., products made of latex), by the intended use of the product (e.g., products used by surgeons during a heart surgery), general industrial knowledge, or by any other set of criteria. These categories may be established by an owner or maintainer of the market platform, or in communication with suppliers and/or buyers of the products. Product associations with particular categories may be mutually exclusive, such that any given product may only be associated with a single category. These categories may be further utilized to assist with a collection of buyer spend data, such that market share compliance may be based upon buyer spend in particular categories. Categories may include a plurality of related products and, in some embodiments, products may be associated with a single UNSPSC to assist with market share compliance measurements.

Product cross-references may be determined in a variety of ways (e.g., by user input, by supplier input where suppliers list products for which their products are equivalent, or the like), and there may be a variety of types of cross-references (e.g., exactly functionally equivalent for all uses, functionally equivalent for some uses). Although the cross-reference data stored in the product datastore 204 is described by example with respect to the medical supply field, the same techniques could be applied to other fields and industries, such as sports equipment, personal protective equipment (e.g., industrial gloves, masks, and aprons), manufacturing parts (e.g., auto parts), general contracting (e.g., nails, tools, lumber), school supplies, lab equipment, or the like.

The contract datastore 206 may include information pertaining to one or more contracts entered into by one or more buyer with one or more of the suppliers. These contracts may include products to be purchased, contract durations, item prices, and various compliance terms. The compliance terms may include various parameters, such as market share levels and associated prices. For example, a buyer may be entitled to purchase an item at a discounted price if they offer the supplier at least 80% market share of their spending in a particular product category (e.g., a particular UNSPSC). If the buyer only provides the supplier with 75% market share (e.g., the buyer purchases 200 items in the particular UNSPSC for a given compliance period, but only purchases 150 items from the particular supplier, or the buyer purchases $10,000 worth of product in a particular UNSPSC but only $7,500 from the particular supplier), the buyer may lose the discounted price, and the supplier may be entitled to recover the difference between the discounted price and the non-discounted price from the buyer, the supplier may be entitled to raise the price for the next compliance period, or other enforcement action may be taken, depending upon the contract parameters. The contract datastore 206 may also include price proposals offered by suppliers, but which are not accepted by the buyer. For example, the contract datastore 206 may store proposals created by the suppliers in response to a RFP generated by the buyer. As an alternative example of an over-compliance scenario, if the buyer were to purchase products equivalent to a 90% spend in a given market share, when the buyer only originally committed to an 80% category spend, the buyer might be presented with an additional discount for a next term, or a rebate equal to the difference between the discount level offered at an 80% market share versus the actual 90% market share.

The market platform server 202 may also be operable to receive spend data from a buyer spend datastore 208. In some embodiments, the buyer spend datastore 208 may be located at an external computing node from the market platform server 202. For example, the buyer spend datastore 208 may be implemented as a purchase order and invoicing or material management system used by the buyer to order products from one or more suppliers. The buyer spend datastore 208 may include an application programming interface (API) used to supply the spend data to the market platform server 202 as orders are placed or invoiced by the buyer. Although the buyer interface 210 and the buyer spend datastore 208 are represented as separate blocks in the illustration, these entities may also be implemented as a single entity, such as a computer node that provides both an interface to the market platform aspects of the market platform server 202 in addition to supplying the market platform server 202 with buyer spend data.

In some embodiments, the buyer spend datastore 208 may be an ERP system or a materials management system, and queries may be used to extract spend data from purchase orders. For example, Structured Query Language (SQL) queries may be performed at particular intervals (e.g., once a day, once a week, once a month), to extract item prices, quantities, model numbers, and the like, and report the extracted data as customer spend data. As alternative or additional examples, buyer spend data 208 may be provided to the market platform server 202 as a file periodically generated and/or extracted by a buyer. For example, a hospital may periodically generate a spend data file from invoice data. Such a file may be provided in a comma delimited format, such as a set of comma separated values (CSV) or a spreadsheet. As another additional or alternative embodiment, spend data may be placed in a particular storage location by the buyer (e.g., at a particular disk or network location), and periodically retrieved by the market platform server 202. The market platform server 202 may perform actions to normalize the data for generating analytics and/or benchmarks for the spend data across multiple buyers and/or suppliers. The market platform server 202 may also use the spend data to determine whether the buyer is meeting market share commitment levels (e.g., by comparing the total number of products purchased in a particular product category vs. the number of products in that category purchased from a particular supplier, or the total amount of spending in the particular category vs. the amount of spending with the particular supplier). Spend data may be tracked over a period of time, and beyond a particular month. For example, in some circumstances, buyer invoices may be reconciled beyond the month in which the purchase is invoiced, so spend data may be captured up to three months after the particular month, and invoices received during this time may be reconciled to the date in which the associated purchase was made.

In some embodiments, the buyer spend data 208 may allow for compliance monitoring at various levels of granularity. For example, a buyer may include multiple facilities or locations (e.g., a hospital system with multiple branches). The buyer spend data may allow for analysis and analytics to determine compliance at an individual facility level by examining only purchase orders and/or invoices from that particular facility. Similarly, on the purchaser side, the spend data may identify which facilities are experiencing backorders from the purchaser, informing the supplier as to which distributors may be experiencing problems.

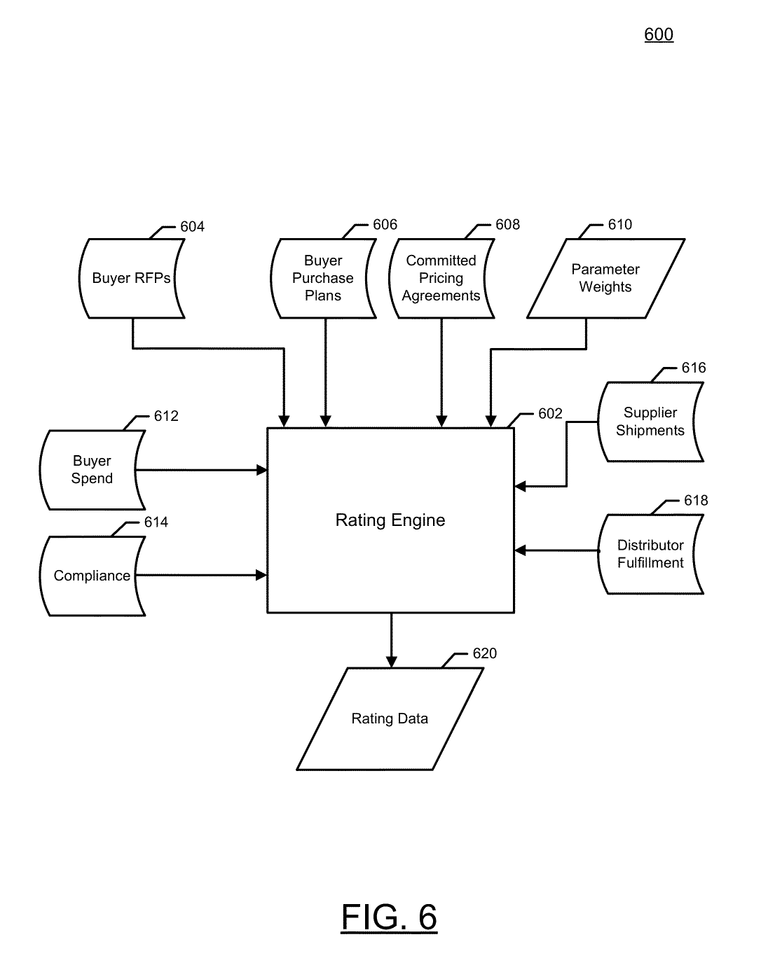

The ratings datastore 218 may store ratings for participants derived from the participant behavior. These ratings may reflect an assessment of factors that may indicate the desirability of engaging with a particular participant via the market platform. For example, ratings may provide indications of various desirable or undesirable behavioral traits exhibited by participants, including but not limited to a confidence in the validity of product cross-references provided by a particular supplier, a favorability of legal terms for contracts offered by a particular supplier, an assessment of the quality of sales support and assistance provided by a particular supplier, an indication of a favorability of pricing offered by a particular supplier, an indication of a likelihood that a particular buyer will comply with an agreed upon market-share commitment, an indication of the likelihood that a particular buyer will alter their purchasing behavior in response to an RFP created by the buyer, or the like. In some embodiments, a participant rating may represent a weighted score derived from participant behavior, such as how frequently a buyer meets agreed-upon market share commitment levels, how frequently a supplier suffers backorders, or how frequently a distributor suffers shipment delays. The market platform 202 may observe and monitor participant behavior and utilize a ratings engine (see FIG. 6) to derive the ratings based on the observed behavior.

Buyers, suppliers, and distributors may interact with the system 200 via a buyer interface 210, a supplier interface 212 and a distributor interface 214, respectively. The buyer interface 210 may allow buyers to specify product supply needs to the market platform server 202, to review purchase plans generated by the market platform server 202, and enter into purchase contracts provided by suppliers. Contracts to which the buyer and supplier have agreed may be memorialized by the market platform as committed pricing agreements. These contracts may be generated by applying the terms of a particular pricing proposal to a template based on a set of rules, terms, and categories specified by the market platform. For example, prior to use of the market platform system, the buyer and supplier may each agree to certain base terms by which supply contracts generated by the system will be governed. When the buyer receives a response to a RFP, the price response may include a set of pricing terms. The buyer may make selections from these terms (e.g., market share commitment levels, contract duration, etc.), and apply these selections, along with pricing terms associated with said selections, to a committed pricing agreement template as defined within the previously agreed-to terms and conditions. The template with the terms from the pricing proposal applied may be used to generate a finalized committed pricing agreement containing contract language that includes the selected terms and associated prices. Buyers and suppliers may utilize e-signature technology to execute a committed pricing agreement generated by the system in this manner. The buyer interface 210 may also allow for viewing of analytics, benchmarks and compliance data derived from buyer spend data, so that buyers may monitor the status of their purchases and contracts. The buyer interface 210 may also enable buyers to create one or more RFPs to solicit pricing offers from suppliers.

In some embodiments, the buyer may utilize the buyer interface 210 to provide product cross-references to indicate similar or functionally equivalent products, and to rate and/or review products to notify other buyers of the performance of products they have used. The buyer interface 210 may include a login system that requires buyers to establish login credentials, ensuring that buyers only have access to their own data.

The supplier interface 212 may allow suppliers to provide data to the market platform server 202. Suppliers may provide information about their products, such as product names, product prices and/or pricing models. The suppliers may also use the supplier interface 212 to respond to RFPs initiated by buyers. RFP responses provided by the suppliers may include one or more pricing proposals, including contract parameters that are variable by one or more factors, such as the market-share example described above. The contracts may also include compliance provisions, payment provisions, penalties, and the like.

The buyer interface 210, the supplier interface 212, and the datastores 204-208 may communicate with the market platform server 202 via a network 216. For example, the buyer interface 210 and the supplier interface 212 may be implemented as a web interface, accessible to buyers and suppliers via the Internet. As described above, the market platform server 202 may be configured to interface with a variety of computing devices located at the same or different nodes of the network 216.

The system may also include a market interface 214. The market interface 214 may provide administrative, management, and/or analytic services for interacting with the market platform. For example, the market interface 214 may provide access to analytic data generated by the market platform server 202 using the buyer spend data and contract information. The market interface 214 may provide an external or administrative user with access to various administrative and management functions, including but not limited to maintenance of user accounts and information, extraction of analytic data, generation of reports, or the like. In some embodiments, the market interface 214 may provide the ability to access analytic data to third parties external to the system.

The system 200 may also include a distributor interface 216. The distributor interface 216 may provide distributors with access to the market platform to inform other participants of the terms and conditions the distributor is capable of offering for distribution of products from a supplier to a buyer. For example, the distributor interface 216 may allow a distributor to provide their particular costs for storage and delivery of particular products offered by the supplier, to assist suppliers and buyers with selection of an optimal distributor for a particular product or product category. The market platform 202 may track distributor behavior, such as product shipments and markups similarly to how buyer spend and supplier fulfillment behaviors are tracked, and analytics may be generated based on the distributor behavior.

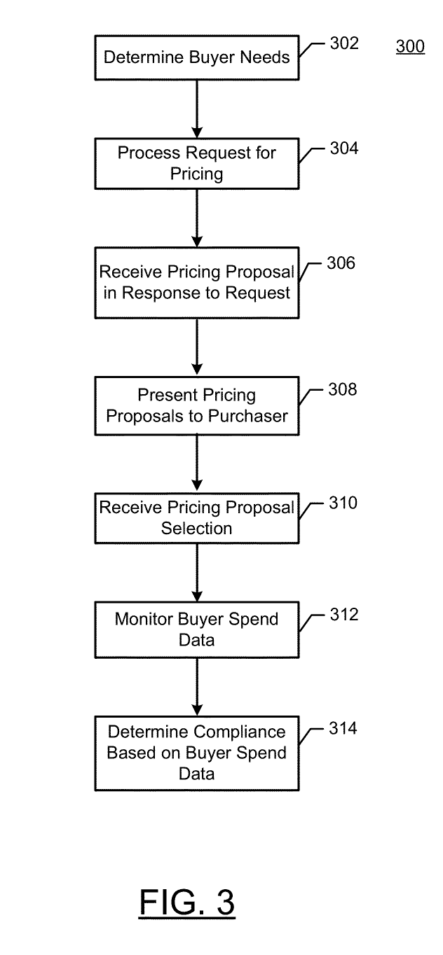

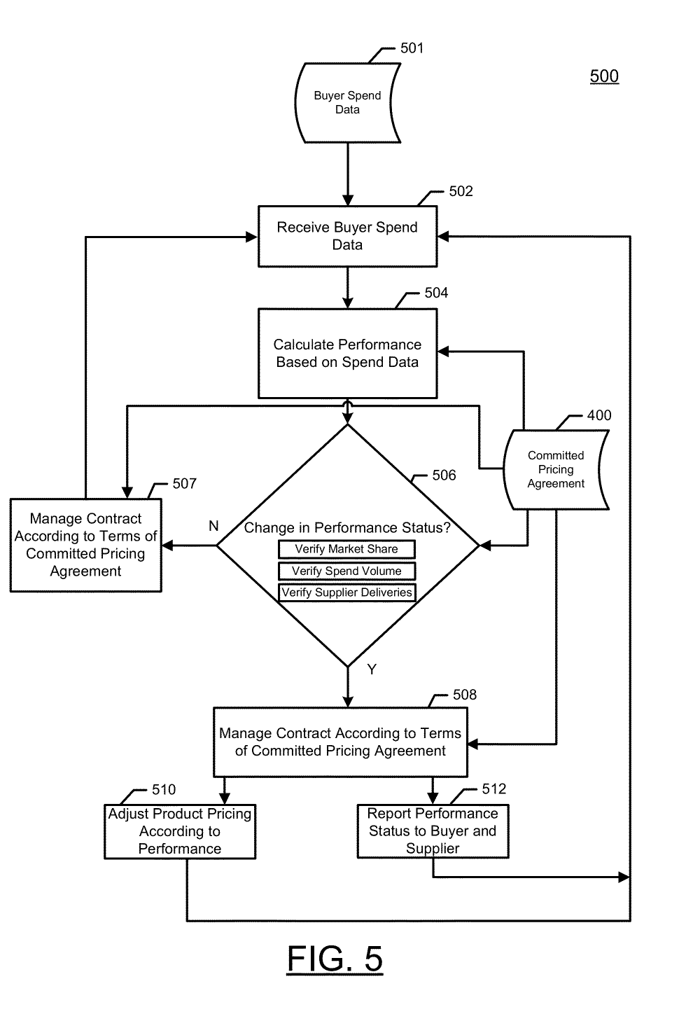

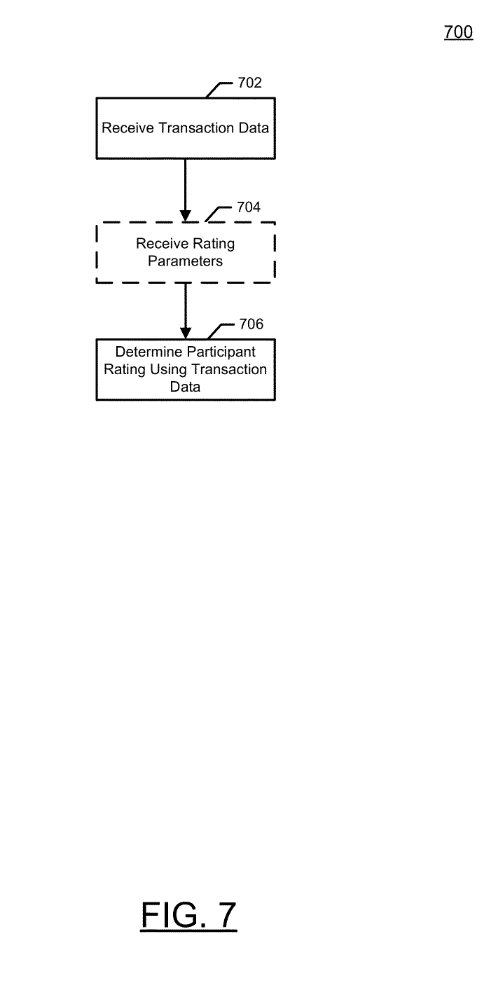

As described above the market platform server 202 may be operable to receive buyer product requirements in the form of one or more RFPs, to receive supplier price proposals in response to the RFPs, to generate a purchase plan for the buyer based on the supplier responses, to allow the buyer and supplier to enter into one or more contracts, and to determine compliance with the provisions of the entered contracts. Example methods for performing this functionality are described further below with respect to FIGS. 3 and 5. The market platform 202 may be further operable to determine ratings for participants using the market platform to assist and inform other participants during the contracting process. Example methods for deriving and utilizing these ratings are described further below with respect to FIGS. 7-11.

To assist the supplier with responding to buyer RFPs, the market platform may offer various tools and techniques for generating product pricing data for consideration by the buyer. These tools may include a multi-dimensional array representation of discount levels for products within a category, with market share commitment levels, sales volume numbers, and/or additional contract parameters along axes of the array. Particular pricing models may be established for each product in a category or the category as a whole, and these pricing models may be provided in a format that allows for saving, loading, and copying of price information to simplify the process of responding to an RFP. Pricing models may also be associated with particular buyers or buyers of a particular size or other buyer characteristics, to prevent the supplier from having to recreate the entire pricing model from scratch for every RFP. Example embodiments of methods and systems for providing a pricing utility are described in U.S. patent application Ser. No. 13/765,479, which is herein incorporated by reference in its entirety.

The market platform may store data relating to purchase plans and pricing responses derived for buyers from one or more contract offerings provided by the suppliers. The market platform may provide a purchase planner for interacting with this data. The purchase planner may enable a buyer to view proposals offered by multiple suppliers and to examine different mix scenarios to identify an optimal set of proposals to meet the buyer's needs from the available proposals. The purchase planner may allow for the buyer to alter market share commitments and contract durations to determine the impact of the alterations on the buyer's overall purchasing. As the buyer changes commitment levels for a first proposal, the purchase planner may ensure that the buyer does not exceed 100% category market share commitment by adjusting other selected proposals as needed. The category market share commitment may be determined based on the supplier's maximum potential market share in the category, rather than the overall market share for the category. For example, a supplier may not offer a particular product or product cross-reference for an item in a category purchased by the buyer. Purchases of this product which the supplier does not offer would not be used to calculate the market share provided by the buyer in such a scenario. As such, buyer market share calculations may not be affected where suppliers provide different levels of coverage in a category. This also means that two or more contracts in a given category may be able to reach market share commitments that exceed 100% in aggregate, as different suppliers may not have overlapping coverage in the same category, such that purchasing a product from a first supplier does not reduce the market share of a second supplier. The purchase planner may also allow the buyer to “lock” certain proposals such that alteration of other proposals does not impact the locked proposals. The purchase planner may also allow the buyer to optimize for different contract mixes and to see the proposals that result in these optimal mixes. For example, the buyer may optimize for a maximum cost savings, minimum product conversion, a minimum number of suppliers, or various other contract mixes. Example embodiments of methods and systems for providing a purchase planner are described in U.S. patent application Ser. No. 13/765,507, which is herein incorporated by reference in its entirety.

The market platform may include various applications, interfaces, and methods for enforcing compliance with the terms of contracts entered into between buyers and suppliers. These contract terms may relate to market share commitment levels, contract durations, other contract terms and conditions, enforcement terms and conditions, and the like. By reviewing and analyzing buyer spend data, the market platform may accurately determine whether both parties are meeting their obligations under the agreed-upon contracts. In the event that one or both parties are not in compliance (or in over compliance), the market platform may dynamically enforce the terms of the contract as specified in the original agreement.

For example, in a scenario where the buyer is not meeting an agreed-upon market share commitment for product purchases within a particular category, the market platform may notify the supplier of the under compliance, and provide the supplier with various options as specified under the original contract. These terms may include adjusting the price of the products for the next compliance period, requesting a payment from the buyer in the amount of the discount level that the buyer failed to meet, or various other contract measurement and/or enforcement methods. By ensuring compliance with the terms of the contract, the market platform advantageously provides suppliers with accurate data about compliance. Because suppliers are provided with accurate compliance data, the suppliers do not need to budget for possible unverifiable under compliance by the buyer, nor do the suppliers need to conduct audits to verify compliance. As such, suppliers may offer buyers lower prices or price rebates due to the accurate reporting of data. Example embodiments of methods and systems for enforcing and monitoring compliance are described in U.S. patent application Ser. 13/765,443, which is herein incorporated by reference in its entirety.

FIG. 3 depicts a flow diagram of an example method 300 for implementing a market platform in accordance with some example embodiments. The method 300 is an example of a process performed by a market platform, such as the market platform server 202, to assist buyers with requesting and selecting one or more contract proposals provided by one or more suppliers, and to assist suppliers with monitoring and enforcement of contract provisions, such as market share commitments.

At action 302, the method receives a set of buyer needs. As described above, the buyer needs may be derived from a set of spend data provided by the buyer (e.g., 3 months, 6 months, or 12 months of spend data), or the buyer may manually generate a RFP to request pricing for a particular product, product category, or group of products/product categories. These needs may be identified based on purchasing efficiency analytics and benchmarks, examination of a contract bid calendar, identification of expiring contracts, or the like.

At action 304, a RFP may be generated by the method in response to input received form the buyer at action 302. The RFP may be provided to one or more suppliers to allow the suppliers to generate pricing proposals in response to the RFP.

At action 306, the method 300 may receive pricing information, such as contract parameters, in response to the RFP generated at action 304. As described above with respect to FIG. 2, suppliers may present one or more pricing proposals to meet some or all of the needs of the buyer, and the market platform may analyze these pricing proposals to generate a purchase plan for the buyer.

At action 308, the method 300 may present the pricing options (e.g., a series of contracts with buyer's options one or more parameters) received from the suppliers to the buyer. The pricing options may be presented as a series of pricing proposals with different contract parameters and/or discount terms, or, as described above, the user may be presented with a purchase plan that provides a selection of optimal contracts or sets of one or more contracts for the user. Upon acceptance of one of these pricing proposals by a buyer, a contract may be generated from the terms of the pricing proposal.

At action 310, the method 300 may receive a selection of pricing options from the buyer. As described with respect to FIG. 3, the market platform may generate a contract or other committed pricing agreement from the selection. This selection may indicate that a contractual relationship has been entered into between the buyer and supplier at the terms specified in the selected contract.

At action 312, the method 300 may monitor buyer spend data to track compliance with the terms of the selected contract. In cases where compliance is based on market share, the method 300 may determine market share levels by comparing the purchases of the product from each supplier with the total purchases of products in that product category from all suppliers. At action 314, the data derived from the spend data (e.g., market share levels) may be compared against the terms of the contract to determine if the buyer is in compliance. In circumstances where the buyer is not in compliance, the market platform may notify the supplier to take appropriate action, or the market platform may automatically enforce the terms of the contract (e.g., by raising the price of the products, or by imposing a penalty on the buyer to be paid to the supplier in the amount of the contract deficiency).

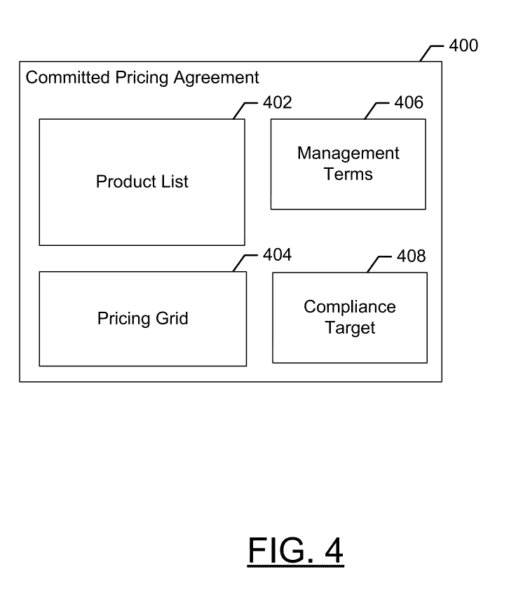

FIG. 4 depicts a block diagram of an example committed pricing agreement 400 in accordance with some example embodiments of the present invention. Once the buyer and supplier agree to contract terms, the agreement may be memorialized as a committed pricing agreement. The committed pricing agreement 400 includes the various terms, conditions, products, and pricing terms related to the agreement entered by the buyer and supplier. The market platform may use such a committed pricing agreement to monitor and inform the buyer and supplier of contract compliance. The committed pricing agreement 400 may include a product list 402, a pricing array 404, management terms 406, and a compliance target 408. In some embodiments, the committed pricing agreement 400 may be associated with a particular buyer facility or set of facilities. In such embodiments, the committed pricing agreement 400 may also include a listing of these associated facilities (not shown), or the facilities may be included in the management terms 406.

The product list 402 may include a list of the products which are the subject of the particular agreement between the buyer and the supplier. For example, the product list 402 may include all products within a particular category that the buyer has the opportunity to purchase from a supplier, or the product list 402 may include a list of all products that the supplier offers in the category.

The product list 402 may be used in conjunction with the pricing array 404 to determine prices for each product based on an achievement level. For example, the pricing array 404 may include a set of discount terms or a set of product prices that correspond to variable parameters associated with the committed pricing agreement. As the variable parameters change due to the achievement of the buyer and the supplier, the system may notify the buyer and supplier of these changes, and initiate contract enforcement as appropriate according to the management terms 406 of the contract.

The management terms 406 may include parameters or contract models that dictate how changes in the contract caused by achievement of the parties should be addressed. For example, the management terms 406 may indicate that, upon underachievement or over achievement (e.g., failing to meet a market share target or reaching a higher market share target), the buyer and supplier should be notified by the underachievement or over achievement, such as by an e-mail, text message, or telephone call initiated by the market platform. In some embodiments, the management terms may cause actions to take place in response to underachievement or over achievement. For example, the buyer and supplier may agree that product prices should be dynamically adjusted based on measured achievement according to the discount terms within the pricing array 404.

The compliance target 408 may be used to track ongoing achievement of the buyer and/or supplier against a target agreed to by the buyer and seller when establishing the committed pricing agreement. For example, the compliance target 408 may track market share, sales volume, invoice status, product delivery status, or any other variable which may affect management of the contract and/or alteration of prices as reflected in the pricing array 404. This compliance target 408 may function as a fixed value against which achievement is measured (e.g., whether a party is complying, under complying, or overcomplying relative to the target). For example, the compliance target may be established based on commitments made by the buyer and supplier during the contract negotiation process. The buyer may indicate to the supplier that they will offer an initial market share commitment level or an initial spend volume. If the buyer exceeds the market share commitment level, they may be provided with an additional discount, a release of funds from escrow, or a rebate payment from the supplier in accordance with the terms of the contract associated with over performing with respect to the compliance target. Alternatively, if the buyer fails to meet the compliance target, they may be responsible for remuneration to the supplier.

In some embodiments, the committed pricing agreement may dynamically adjust based on past achievement, and the compliance target 408 may function as an ongoing compliance target. As both parties perform the contract, the compliance target may be updated, and the pricing terms of the agreement updated as achievement changes. For example, the compliance target may be updated at periodic intervals, such as at the end of a monitoring period. For example, pricing terms may be updated based on whatever compliance level each party reached during the previous monitoring period, and the compliance level reached may be established as the new compliance target for the next compliance term. In some embodiments, the pricing terms may not be automatically updated, but the parties may instead be notified so that the parties can separately determine how to enforce the terms of the agreement. The compliance target may also be updated for the supplier. For example, the system may ensure that buyers are paying the correct, negotiated price for products under the terms of the agreement by monitoring buyer spend and invoice data and comparing said data to the terms of the committed pricing agreement. As such, embodiments of the invention may provide for both static (e.g., initial, unchanging compliance targets) and dynamic (e.g., updated pricing every compliance period) uses of the compliance target 408.

Actions taken in response to achievement measurement may be determined according to various contract models. Examples of these contract models include a variable price model, a fixed price model, an escrow model, an insurance model, and a buy-in model. In a variable price model, the buyer may agree to a range of prices based on various achievement parameters (e.g., market share levels). The buyer may designate a particular initial target achievement level, and the supplier may offer the buyer pricing consistent with the initial target achievement level. If the buyer fails to meet the target achievement level, the supplier may be presented with the option to, or the market platform may automatically, adjust the buyer's pricing to pricing associated with the appropriate pricing level, moving forward.

In a fixed price model, as in a variable price model, a buyer may also agree to a range of prices based on achievement parameters, and the buyer may designate an initial target commitment level. If the buyer fails to meet the target commitment level, the buyer may be liable to the supplier in the form of a penalty (e.g., the difference in price between what the buyer paid and what the buyer should have paid based on the parameters of the pricing array, multiplied by the number of products purchased by the buyer). In the case of the buyer over performing and exceeding the target commitment level, the buyer may be entitled to a bonus from the supplier consistent with the commitment level that the buyer actually reached. As with each of these options, the market platform may automatically enforce pricing adjustments and payouts, or the market platform may inform the buyer and supplier of compliance and allow the buyer and supplier to reach terms outside of the market platform environment.

The escrow model may allow the buyer and supplier to set a standard price and an “effective” price, where the effective price is the price the buyer would pay if the buyer is compliant throughout the term of the contract. In the escrow model, buyers pay the standard price, while suppliers put the difference between the standard price and the effective price in an escrow account. The escrow is paid out periodically to the buyer at a pre-determined rate as the buyer complies with the terms of the contract.

The buy-in model may allow the buyers to pay an upfront buy-in amount to a contract that represents a difference between the supplier's standard prices and the supplier's contracted prices. As the buyer demonstrates compliance with the contract, the buyer is provided with the ability to draw down on the buy-in amount in proportion to the duration and/or degree of compliance. If a buyer is non-compliant, the supplier would receive the proportional buy-in amount as restitution.

A rebate model may allow buyers to pay market price for products, but receive a rebate from suppliers based on meeting certain commitments. For example, a rebate may be provided to the buyer in the amount of the difference between the purchase price of the goods and the discounted purchase price associated with the achievement levels met by the buyer.

In an insurance model, buyers may purchase an insurance policy to spread the risk of non-compliance among a risk pool. For example, if a buyer purchases the insurance policy and is later under compliant with the terms of the committed price agreement, then the insurance policy may pay the supplier to cover for the buyer's non-compliance (e.g., by paying the suppliers the difference between the negotiated price and what the price should have been based on the buyer's compliance level). Such an insurance policy may adjust the buyer's premium based on a compliance history for the buyer over previous contracts. For example, a buyer that has a strong history of compliance may be expected to pay a low premium, while a buyer that has a history of non-compliance may pay a higher premium. In this manner, buyers may apportion the risk of non-compliance across a larger risk pool, while still reaping the benefits of discounted prices due to increased commitment levels.

In a drop ship model, supplier may initiate shipment to buyers at the end of a compliance period in order to bring the buyers into compliance with previously agreed commitment targets. For example, if a buyer has not purchased enough products in a particular category to meet a market share commitment target, then the supplier may be authorized to automatically ship enough products to the buyer such that the buyer meets the target commitment level.

FIG. 5 depicts a flow diagram illustrating an example method 500 for providing contract compliance monitoring in accordance with some example embodiments of the present invention. The method 500 enables a buyer and a supplier to monitor the achievement of both parties based on the spend history of the buyer and according to a previously negotiated committed pricing agreement. The buyer and supplier may thus adjust price levels for underachievement or over achievement by one or both parties to conform to agreed pricing terms. The method 500 may allow for adjustment of price levels or various terms to be enforced automatically by a computer system, such as a market platform server, or the method 500 may function to inform the buyer and supplier of compliance and allow the parties to determine how to proceed. For example, if a buyer agrees to a first price at a first market share commitment level, and the buyer exceeds that first market share commitment level to reach a second, higher market share commitment level, the method 500 may adjust pricing of products sold under the agreement to a discount level associated with the second market share commitment level. The method 500 may be performed by a market platform, such as the market platform 202 described with respect to FIG. 2, and the committed pricing agreement may be a committed pricing agreement 400 as described with respect to FIG. 14.

At action 502, the method 500 receives buyer spend data from a buyer spend data source 501. As described above, the buyer spend data 501 may be received by analysis of buyer invoice and/or purchase order data, recall alerts from a supplier, from a buyer ERP or materials management system, by extracting data from one or more files provided by the buyer, or the like (see FIG. 2). At action 504, achievement, such as a market share commitment level reached by the buyer, is determined from the buyer spend data. For example, the buyer spend data may be analyzed to determine the total buyer spend for items in a product category available from the supplier, compared to the total amount the buyer could have spent in the category if the buyer did not buy products from other suppliers. As another example, the buyer spend data may be analyzed to determine the total volume of product sales the buyer purchased from the supplier within the category.

At action 506, a determination is made as to whether there has been a change in achievement status based on the analysis of the spend data at action 504. As described above, a committed pricing agreement 400 may store a compliance target 408 for the agreement. This compliance target may reflect the previous achievement levels of the parties (e.g., the sales volume for the previous review period), or an initial commitment level (e.g., a commitment level negotiated upon execution of the agreement). Action 506 may include verifying whether this status has changed. For example, the method 500 may determine whether the current achievement levels indicate a change in market share, sales volume, or supplier deliveries that would cause a change in the status of the agreement. For example, if the buyer has met but not exceeded a market share commitment level, then no action may be taken by the buyer or supplier. However, if the buyer has exceeded the market share commitment level, then it may be appropriate to offer a benefit to the buyer (e.g., a larger discount), or if the buyer has not met a target market share, then the buyer may receive a penalty (e.g., payment to the supplier of the difference between the discount for the actual market share reached and the discount for the original commitment level). If the achievement is consistent with the previous compliance target, then the method proceeds to action 507 to manage the contract according to the terms of the contract consistent with ongoing compliance with the contract. Otherwise, the method proceeds to action 508 to provide enforcement consistent with the terms of the contract where performance has changed.

At action 507, if the terms of the contract specify some action to take place in response to no change in the performance status (e.g., a buyer meets but does not exceed an agreed upon performance level), certain actions may be taken. For example, the buyer may receive a benefit for meeting their current performance commitment, such as a rebate offered in a rebate contract model. The method may return to action 502 to continue monitoring of performance after managing the contract.

At action 508, the contract is managed according to the terms of the agreement in view of the change in performance status detected at action 506. These terms may be defined within the committed pricing agreement 400. For example, the management terms 406 (see FIG. 4), may describe measures to be taken in response to a change in achievement status. These management terms may, for example, ensure that the market platform informs both the buyer and the supplier of the compliance target of the agreement in the event of under achievement or over achievement. For example, the market platform may send an e-mail to the buyer and supplier with the compliance target of each party. The buyer and supplier may thus optionally take appropriate action. For example, a supplier may elect not to enforce a price increase for a good customer that regularly meets market share commitment levels, but has a single lapse.

Alternatively, the method 500 may provide for automatic enforcement of contract provisions. For example, contracts may include a set of variable terms that adjust based on buyer and supplier achievement. As these variables change, so too do elements of the contract. One example is where prices are provided according to a pricing array, where axes of the array are related to different variables such as sales volume or market share. As these variables adjust, the buyer is offered discount levels consistent with the variable values. In embodiments where the market platform is configured to automatically enforce the terms of the contract, these prices may dynamically update as the achievement of the parties changes. For example, different contract models may have different enforcement provisions, such that a variable price contract may update a price for the next contract period in response to under or over achievement, while an escrow contract may refund a difference between a standard price and a discount price when the buyer is compliant with the terms of the contract. As such, while action 508 is described as occurring in response to a determination that achievement is not consistent with the commitment levels, contract enforcement could alternatively take place in response to achievement that meets or is otherwise consistent with predetermined commitment levels.

Actions 510, and 512, describe example actions that may be taken to manage the contract. For example, at action 510, pricing terms may be adjusted for the contract according to the established achievement levels and a pricing array 404 associated with the committed pricing agreement. At action 512, the buyer and supplier may be notified of the contract status so that they may take appropriate action. After taking appropriate action to manage the contract in view of the achievement, the method 500 may return to action 502 to continue receiving buyer spend data to manage the contract.

FIG. 6 depicts a flow diagram illustrating a process 600 for providing inputs to a rating engine to derive rating data in accordance with some example embodiments. As buyers, suppliers, and distributors interact with the market platform to perform transactions, the market platform may observe participant behaviors such as participant spending (e.g., purchase orders and invoices), RFPs, pricing responses, generated analytics and benchmarks, purchase plans, contract details, compliance data, distributor data, and payment data. Ratings for the participants may be dynamically adjusted as transactions are observed by the market platform. The process 600 depicts some example data sources that may be employed by a rating engine 602 (e.g., a software and/or hardware component of a market platform, such as the market platform server 202 described with respect to FIG. 2) to derive a set of rating data 620.

The rating engine 602 may be configured to receive transaction data and to process the transaction data to assign ratings to participants. The transaction data may be gathered by passive monitoring of transactions performed by participants using the market platform. The rating engine 602 may thus have access to various types of transaction data, including but not limited to buyer RFP data 604, buyer purchase plan data 606, committed pricing agreement data 608, buyer spend data 612, compliance data 614, supplier shipment data 616, and distributor fulfillment data 618. These sets of data may be analyzed and processed to obtain a rating for participants using the market platform.

The buyer RFP data 604 may include information relating to the buyer's RFP practices. Different buyers may have varying RFP practices. For example, some buyers may frequently initiate new RFPs for particular products or product categories, but rarely execute contracts in association with an RFP. RFPs generated by buyers that frequently “test the waters” but fail to follow through may be less desirable to suppliers, as these buyers appear less likely to enter into a new pricing agreement with a supplier based on a particular RFP response. To detect these buyers, the rating engine may track how often a particular buyer initiates an RFP, and compare this frequency with how often the buyer engages in a committed pricing agreement arising out of an RFP. Buyers that regularly “follow through” on their RFPs may have a correspondingly higher buyer rating than buyers that fail to respond to supplier responses to their RFPs. For example, the rating engine 602 may determine a buyer RFP rating by dividing the number of RFPs initiated by the buyer that result in a committed pricing agreement by the total number of RFPs initiated by the buyer to determine an RFP success percentage value. This buyer RFP rating may be provided to other participants directly, or it may be used in conjunction with various other weighted metrics and analytics to derive an overall “score” for a participant.

The buyer purchase plan data 606 may include information relating to buyer purchase plans generated using the market platform. As described above, buyer purchase plans may provide a guide for how the buyer intends to allocate spending across various products, such as products in a category. This purchase plan data may be monitored by the rating engine 602 in conjunction with the buyer's spending data 612 to determine how well the buyer is sticking to their intended purchase plan. Buyers that show discipline in planning their purchases and sticking to their plans may be associated with a higher buyer rating than buyers that fail to adhere to their purchase plans. For example, the rating engine 602 may determine a buyer purchase plan deviation rating by identifying a percentage deviation in buyer spending between the buyer actual spending and the buyer's planned spending in a particular category. This buyer purchase plan deviation rating may be provided to other participants directly, or it may be used in conjunction with various other weighted metrics and analytics to determine an overall “score” for a participant.

The committed pricing agreement data 608 may provide the rating engine with information about the committed pricing agreements into which participants have entered. This committed pricing agreement data 608 may be used to verify the frequency with which buyers follow through on RFPs (see buyer RFP data 604, above), and the frequency with which particular buyers and suppliers are able to come to an agreement. Participants that follow through on RFPs and establish committed pricing agreements may be associated with higher ratings than participants that fail to come to agreement. Participants may be associated with a committed pricing agreement data 608 based on a number of committed pricing agreements entered by the participant. For example, a CPA rating may be derived based on the absolute number of CPAs into which the participant has entered, where a larger number of CPAs mean a higher rating. In some other embodiments, the CPA rating may be derived using the spend/sales volume of the participant or the number of categories in which the participant participates, where the number of CPAs is weighted such that smaller or lower volume participants may receive a higher CPA rating for the same number of CPAs than larger or higher volume participants.

The buyer spend data 612 may be used by the rating engine to monitor the purchase habits of buyers and to determine the spending volume of the buyer, along with how well the buyer adheres to their purchase plan(s) and/or how well the buyer meets previously agreed market share commitments (e.g., based on compliance data derived from the buyer spend data 612). Participants that have a large volume of spending or sales, or buyers that adhere to their purchase plans may be associated with a higher rating. Similarly to a CPA rating, participant ratings may be associated with spend data in absolute terms (e.g., higher spend/sales results in a higher rating), or weighted based on the characteristics of the participant.

The compliance data 614 may indicate how well participants have complied with the terms of previous committed pricing agreements. For example, the compliance data may indicate whether a buyer met particular market share commitment levels, or whether a supplier provided products in a timely manner without backorders, delays, or recalls. A compliance rating may be derived from the compliance data. For example, a compliance rating for a participant may be calculated by dividing the number of committed pricing agreements into which the participant is compliant by the total number of committed pricing agreements into which the participant has entered. In some embodiments, the compliance rating may be further weighted based on how close the participant was to achieving compliance for each contract (e.g., reaching a 89% market share commitment level for a CPA that required 90% market share might result in less of an impact on the participant's compliance rating than reaching a 20% market share commitment level for a CPA that required 70% market share), by the length of each contract (e.g., achieving compliance over a 5 year contract term might impact the participant's compliance rating more than achieving compliance over a 1 year contract term), by how recent each instance of compliance/non-compliance occurred, and the like. In some embodiments, compliance data may be weighted based on the size of the CPA associated with the compliance (e.g., based on the dollars of spending associated with the CPA). For example, a CPA associated with $1,000,000 in spending might be weighted more heavily for determining a compliance rating than a CPA with $10,000 in spending.

The supplier shipment data 616 may be used to determine a shipment rating for the supplier. For example, the shipment data 616 may indicate which products were shipped by a supplier, when the shipments occurred, to which buyer the shipment was sent, and in response to which purchase order or invoice the shipment was created. The shipment data 616 may also indicate the occurrence of backorders or product recalls. Suppliers may be assigned a shipment rating based on how frequently shipments occur within a particular period of time from a corresponding purchase order. The shipment rating may be reduced in response to detection of a product recall or detection of a failure to provide a product to distributors in a timely manner(e.g., backordered due to the supplier.

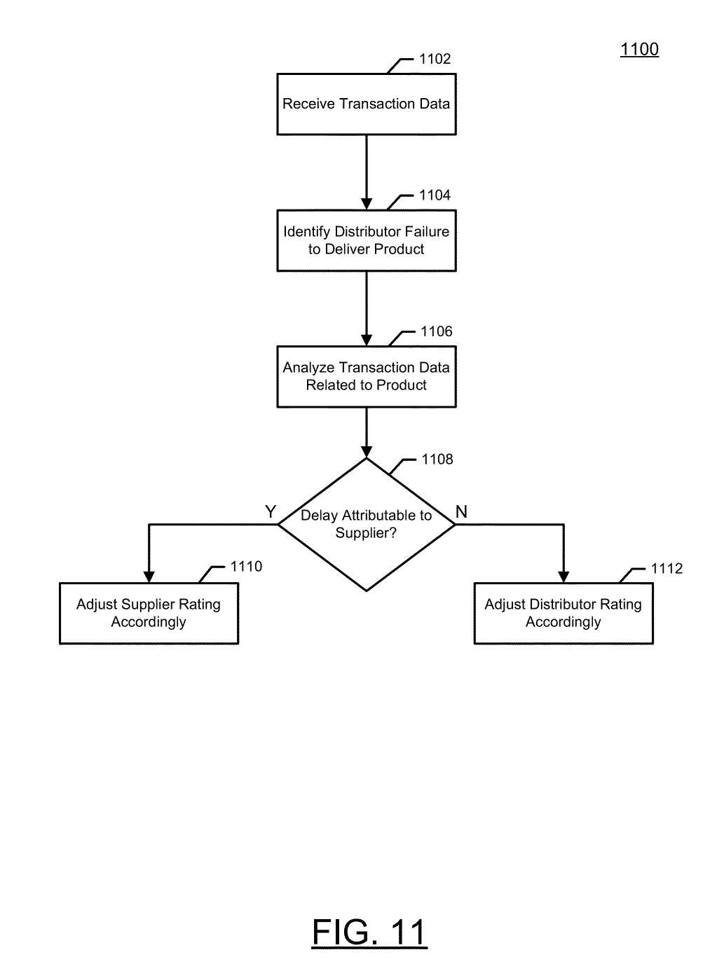

The distributor data 618 may be used to determine ratings for particular distributors. The distributor data 618 may indicate the shipment fee charged by the distributor to deliver the supplier's products, the delay associated with using a particular distributor (e.g., by determining the time from when the supplier ships a particular product to when the product is received by the buyer), whether or not the distributor ever substitutes an alternative product for a supplier's product (which may impact the buyer's market-share compliance level), or the like. Embodiments may further differentiate between supplier backorders and distributor backorders by leveraging access to data provided by the market platform. An example of a method for attributing a delay to the supplier or the distributor is described further below with respect to FIG. 11.

The various data may be processed using a set of parameter weights 610. The parameter weights 610 may define different formulae, metrics, weights, and the like that are used to determine rating data 620 for the participants. These parameter weights 610 may define a single “absolute” rating for each participant using a standard formula/algorithm. For example, the market platform may utilize a standard scoring algorithm for determining a rating for a buyer, using various performance metrics for buyers, a standard scoring algorithm for suppliers using supplier performance metrics, and a standard scoring algorithm for distributors using distributor performance metrics. These standard scoring algorithms may be generated using a combination of one or more ratings for particular performance characteristics. For example, a single buyer rating could be derived by averaging a buyer compliance rating, a buyer RFP follow-through rating, a buyer purchase plan deviation rating, and a buyer CPA rating together to arrive at a uniform buyer rating. Additionally or alternatively, the various ratings and metrics might be accorded different weights by the market platform, and various methods of calculating the participant ratings may be employed.

In some embodiments, participants may alter the parameter weights 610 to generate custom ratings. For example, a particular supplier may wish to place more emphasis on buyer sales volume than past buyer compliance, and as such the seller may increase the weight accorded to the sales volume of the buyer and decrease the impact of the buyer's past compliance on the rating in the calculation used by the ratings engine to determine the buyer rating. In some embodiments, the ratings engine 602 may provide an interface (e.g., the buyer interface, the supplier interface, or the distributor interface described above with respect to FIG. 2) to allow the participant to modify the parameter weights to create a custom rating algorithm. In some embodiments, the rating engine may further allow for the participant to specify particular behavior based on the ratings of other participants, such as altering a default pricing model for a buyer based on the buyer's rating (e.g., giving more favorable pricing for highly rated buyers). It should be appreciated that the rating engine 602 may preserve the “raw” values of data used to derive custom ratings. These parameter weights 610 may therefore provide the capability to alter the calculation of the rating based on the needs or desires of the particular participant.

The rating data 620 may include a rating for each participant expressed in a variety of different manners. For example, the rating data may be represented as a numerical value from 0 to 1000, a percentage value, a letter grade (e.g., A-F), or a percentile value (e.g., the participant is in the 60^{th} percentile of all participants of the same type (e.g., buyer, supplier, distributor)), or a qualitative value (e.g., “Low”, “Medium”, or “High”). In some embodiments, the rating data may be expressed for the participant according to various filters. For example, the rating data may be expressed as a percentile with respect to all buyers/suppliers/distributors, as a percentile for participants of a similar size (e.g., number of employees), as a percentile for participants in the same geographic area, as a percentile for participants with a particular spend volume, or the like.

FIG. 7 depicts a flow diagram illustrating an example method 700 for deriving participant ratings in accordance with some example embodiments. The method 700 enables the market platform to derive participant ratings based on transaction data received via the market platform. The method 700 may provide for the passive observation of product selections, spending allocations, product shipments, contract compliance, and the like, to determine which participants act in a desirable manner. For example, buyers that have a large sales volume, that are regularly compliant with the terms of their CPAs, and that frequently act on RFPs may generally be perceived as desirable to sellers. As such, these desirable buyers may be accorded a high rating to indicate to sellers their desirability. Similarly, suppliers that offer competitive pricing, that rarely issue product recalls, and that ship product in a timely manner may be perceived as desirable to buyers, and thus these suppliers may be accorded a high rating to indicate this desirability to buyers. Embodiments of the method 700 may advantageously derive participant ratings based on transactions performed using the market platform, without the need to actively solicit data from participants using the market platform. Embodiments of the method may be performed by an apparatus, such as the apparatus 102 described with respect to FIG. 1 or the market platform server 202 described with respect to FIG. 2.

At action 702, transaction data may be received by the method 700. For example, as described above, the transaction data may include information on any transaction performed using the market platform. These transactions may include RFPs generated by buyers, RFP responses generated by suppliers, CPAs executed by buyers and suppliers, purchase planning decisions and spending allocations selected by buyers, spending performed by buyers, activation of contracts (e.g., beginning of a compliance period), purchases by or deliveries from distributors, or the like.

At optional action 704, rating parameters may be received. For example, these rating parameters may reflect a custom rating formula received from a participant that alters the weights of particular metrics used to calculate a participant rating, adds metrics to the rating calculation, or removes metrics from the rating calculation. In this manner, the method 700 may advantageously allow for participants to establish custom rating calculations to identify counterparties that are particularly desirable to the particular participant based on criteria that represent factors desirable to the particular participant.

At action 706, a rating for the participant is calculated using the transaction data. As described above, the participant rating may be generated using various metrics, and in some embodiments the participant data may be derived from multiple individual ratings.

Once ratings are associated with particular participants, these ratings may be employed by participants using the market platform to assist with performing transactions using the market platform. For example, suppliers may offer buyers with high compliance ratings more favorable pricing to reflect the lower likelihood that the buyers will fail to meet their compliance obligations, suppliers may devote more time to buyer RFPs from buyers that have a high “RFP follow through” rating, and buyers may use supplier ratings to assist with selection of suppliers as RFP targets or to select between suppliers with otherwise similar product offerings and prices. In some embodiments, ratings may be used by participants to manage risk during contract periods where compliance is otherwise difficult to enforce, such as during an initial compliance ramp-up period, during the first compliance period of the contract, or during the last compliance period of the contract when further price discount adjustments are not possible (e.g. the last compliance period of the contract). For example, a supplier may require a “high risk” buyer (e.g., a buyer with a comparatively low compliance rating) to post an escrow payment during an initial compliance period if the buyer commits to a large discount to hedge against the risk that the buyer does not comply.

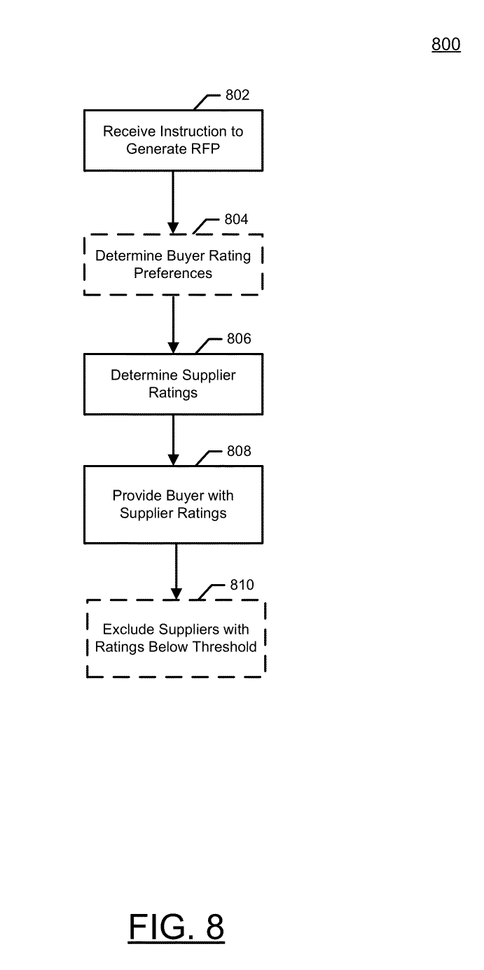

FIGS. 8-10 depict some example methods that employ these participant ratings to assist the participants with transactions performed using the market platform. Although these methods are provided as examples, it should be readily appreciated that the participant ratings could be employed in various additional and alternative embodiments to assist the participants with decision making, risk management, and various other considerations when performing transactions using the market platform.

It should be readily appreciated that participant ratings may be used by market participants in a variety of manners. In some embodiments, the participant ratings may cause automatic adjustments of participant transactions. For example, a supplier may configure their RFP response behavior with rules that select a default price model based on the rating of the buyer, or supplier responses to a buyer RFP may be automatically filtered to remove suppliers with below a threshold rating. In some embodiments, these automatic behaviors may be manually configured or adjusted by each participant, and in some embodiments the automatic behaviors are default properties of the market platform.

In yet further embodiments, participant ratings may induce the market platform to offer suggestions or recommendations to participants, without automatically adjusting parameters of the transaction. For example, the market platform may indicate to a buyer that certain suppliers that responded to an RFP have especially high ratings, and suggest these suppliers for consideration in a purchase plan. As another example, the market platform may recommend a particular price model for use by a supplier in an RFP response based on a rating of the buyer that initiated the RFP.

In additional embodiments, the participant ratings may be provided to the participants for use in whatever manner the participants choose. For example, the participant ratings may merely be displayed during transactions to allow the transacting parties viewing the ratings to use the ratings in whatever manner the transacting parties so choose.

FIG. 8 depicts a flow diagram illustrating an example method 800 for using supplier ratings to inform a buyer during a transaction in accordance with some example embodiments. The method 800 enables a buyer to take into account supplier ratings when initiating an RFP. During the RFP process, the buyer may select particular suppliers that offer products within a desired category to solicit pricing responses from those suppliers. For example, a given category may include 50 different suppliers, but selecting from 50 pricing responses, many of which fail to provide adequate product coverage in a category, might be an overwhelming activity for the buyer. As such, the buyer may wish to select a subset of all suppliers to solicit responses to the RFP. However, the buyer may wish to receive as much data as possible to assist with selection of suppliers from which to solicit price responses. As such, the method 800 may utilize supplier ratings to assist the buyer with selection of suppliers for the RFP process. Although the method 800 is described with respect to selection of suppliers for an initial RFP, it should be readily appreciated that the same or a similar method could also be employed to filter price responses from suppliers or to otherwise assist the buyer with evaluation of suppliers at any time during the contracting process. Embodiments of the method 800 may be performed by an apparatus, such as the apparatus 102 described with respect to FIG. 1 or the market platform server 202 described with respect to FIG. 2.

At action 802, the method 800 receives an instruction to generate an RFP. For example, action 802 may reflect the buyer initiating an RFP using a buyer interface as described with respect to FIG. 2. The instruction to generate the RFP may include a particular product, products, or product category for which the buyer wishes to initiate the RFP, along with various other data about the buyer and/or supplier characteristics deemed desirable by the buyer.

At optional action 804, the method 800 may determine buyer rating preferences. These rating preferences may reflect the supplier characteristics and/or contract parameters deemed desirable by the buyer, or various other criteria relevant to determining a supplier rating customized for the particular buyer. This action is described as optional as buyers may not always specify particular preferences or criteria for evaluating suppliers; instead the buyer may opt to use a default rating algorithm for rating the suppliers.

At action 806, ratings for the suppliers are determined. These ratings may be determined based on the particular buyer rating preferences received at action 804, or the ratings may be determined based on a default rating algorithm. In some embodiments, the supplier ratings may be determined prior to initiation of the RFP, such that the method 800 merely accesses stored ratings for each supplier that may be presented to the buyer for selection in the RFP process (e.g., all suppliers that offer products in the selected category).

At action 808, the buyer may be provided with the supplier ratings to assist with the RFP process. For example, the buyer may be presented with an interface listing each supplier along with the rating determined for each supplier. In some embodiments, the suppliers may be listed in order according to their ratings, such that higher rated suppliers are displayed prior to lower rated suppliers. In some embodiments, suppliers with ratings above a particular threshold level may be displayed with text or an icon indicating that the supplier is an “All-star”, “Platinum Member”, “Preferred Supplier” to denote the fact that the supplier is associated with a particularly high rating. The interface may further allow for sorting based on the supplier rating, the supplier name, or the like. In some embodiments, the buyer may be provided with multiple ratings for each supplier in various behavioral characteristics, and the suppliers may be sortable by these ratings as well. For example, suppliers may have separate rating values associated with backorder frequency, price competitiveness, shipping delays, the frequency with which the supplier adjusts pricing according to compliance levels, or the frequency with which the supplier requires buyers to repay discounts received as a result of market share commitments the buyer failed to reach.

At optional action 810, a list of suppliers provided to the buyer may be filtered based on the supplier ratings. For example, an interface may only display suppliers that exceed a particular threshold supplier rating. In some embodiments, this threshold may be configurable by the buyer.

As described above, the same or a similar method to the example method 800 may also be employed to assist the buyer with evaluation of pricing responses received from suppliers in response to the RFP. For example, supplier ratings may be used to exclude some supplier RFP responses based on scores that indicate supply issues (e.g., many back orders, product recalls, or late deliveries) identified by the market platform's analysis of purchase orders, invoices, or other transactions. The method may also identify or recommend suppliers with higher ratings in the event that other factors (e.g., cost, item quality) are equal or substantially equal (e.g., prices or other metrics within a particular threshold range of one another across suppliers).

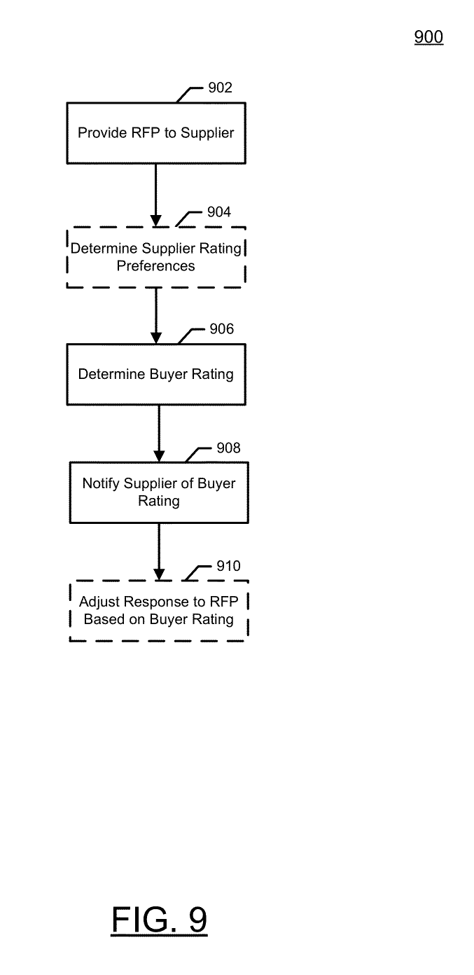

FIG. 9 depicts a flow diagram illustrating an example method 900 for using buyer ratings to inform a supplier during a transaction in accordance with some example embodiments. As with the supplier ratings described with respect to FIG. 8, the example method 900 may similarly provide additional data for consideration by suppliers when performing transactions using the market platform. This data may be used by the suppliers to, for example, determine which RFPs to which they should respond, to determine how much time and effort to devote to a particular pricing response, to determine a risk level for a particular agreement, or to determine a discount level for a particular buyer. The buyer ratings may thus provide sellers with additional data that allows the seller to evaluate the history (or lack thereof) and characteristics of the particular buyer to make an informed decision as to whether and how to engage in a transaction with the particular buyer. Although the example method 900 is described with respect to generation of an RFP response, it should be readily appreciated that the same or similar methods and techniques could be employed to assist and inform the supplier during buyer interactions in various other transactions during, before, or after the contracting process. Embodiments of the method 800 may be performed by an apparatus, such as the apparatus 102 described with respect to FIG. 1 or the market platform server 202 described with respect to FIG. 2.

At action 902, a supplier may be notified of an RFP. As described above, the supplier may be notified that a buyer wishes to receive price responses for a particular product, set of products, or product category. The RFP may also include a set of parameters desired by the buyer, such as various product selections, contract parameters, and the like.

At optional action 904, the method may determine rating preferences for the supplier. These rating preferences may reflect the buyer characteristics or contract parameters deemed desirable by the supplier, or various other criteria relevant to determining a buyer rating customized for the particular buyer. This action is described as optional as suppliers may not always specify particular preferences or criteria for evaluating buyers; instead the supplier may opt to use a default rating algorithm for rating the buyers.

At action 906, a rating may be determined for the buyer that generated the RFP. As described above with respect to FIGS. 2 and 6-8, the buyer rating may reflect how desirable the buyer may be as a contracting party for the supplier based on factors such as, but not limited to, buyer contract compliance, buyer follow-through on RFPs, and the like. The buyer rating may be customized for the particular supplier if the particular supplier provides custom rating parameters as described above with respect to action 904. A given buyer may be associated with multiple ratings reflecting different buyer behavioral characteristics. For example, the buyer may have a separate rating for past market share compliance, volume compliance, compliance over different durations (e.g., over the last year, over the last five years), compliance only in the particular category vs. compliance over all categories, or the like.

At action 908, the supplier may be notified of the buyer rating or ratings. This notification may be provided via an interface that allows the supplier to consider how to respond to the RFP. In some embodiments, the interface may include an icon or text indicating that the buyer is an “All-star”, “Preferred Buyer”, or the like if the buyer's rating exceeds a particular threshold.

At optional action 910, a default price model used to respond to the RFP may be adjusted based on the buyer rating. For example, a supplier may wish to offer more favorable pricing to a buyer with a high rating, reflecting the lower risk in transacting with the buyer. Alternatively, a buyer with a history of non-compliance may be offered an alternative price model (e.g., a lower discount level, or more steeply ramping discount levels requiring higher commitment levels) reflecting the increased risk that the buyer will not be compliant based on their past history.

As described above, buyer ratings may be employed to assist the seller with various other transactions other than RFP responses. For example, buyer ratings may be used to determine discount levels during an initial compliance measurement period, where buyers that have established a history of compliance through their transactions may be afforded a larger discount level during an initial compliance measurement period than buyers without a history of compliance. In some embodiments, the market platform may allow the supplier to configure contract pricing models to automatically give larger discounts to buyers with ratings indicating a past history of compliance. In some embodiments, the market platform may determine discount levels and recommend the determined discount levels to the supplier prior to sending the pricing response. In yet further embodiments, a risk assessment performed based on the buyer's rating may allow suppliers to limit access to the largest discount levels during an initial compliance measurement period until the buyer demonstrates market share performance at those levels if the buyer's rating indicates a history of the buyer committing to a market share associated with a maximum discount level but failing to meet the market share commitment. In yet further embodiments, the method 900 may allow a supplier to provide additional value to buyers that meet particular rating thresholds, such as offering an additional rebate or discount value to a buyer that has a particularly high rating.

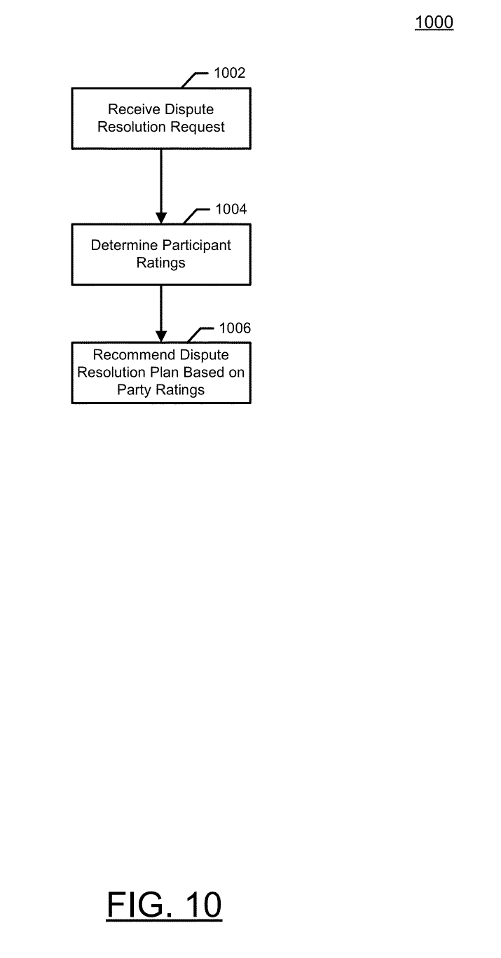

FIG. 10 depicts a flow diagram illustrating an example method 1000 for resolving a dispute using participant ratings in accordance with some example embodiments. In some circumstances, disputes may arise between buyers and suppliers regarding compliance with agreements executed using the market platform. Although the market platform may track most, if not all, transaction data for transactions performed using the market platform, in some cases purchases that are subject to the terms of an agreement may be performed outside of the market platform, resulting in incomplete or unavailable data. In such cases, it may be impossible to resolve disputes in a clear an unambiguous manner. As such, the method 1000 describes a process by which participant ratings may be utilized to recommend dispute resolutions by relying on the past behaviors of the parties to the transaction. Embodiments of the method 800 may be performed by an apparatus, such as the apparatus 102 described with respect to FIG. 1 or the market platform server 202 described with respect to FIG. 2.

At action 1002, a dispute resolution request may be received. The dispute resolution request may be performed by one or both participants to a transaction to indicate that the participant believes there is a discrepancy between the performance and enforcement of an agreement. For example, a buyer may file a dispute resolution request if the buyer believes they have not been provided with pricing commensurate with a market share commitment level reached by the buyer. It should be appreciated that participant ratings may not be used in circumstances where it is possible to determine unambiguously that one or the other party is at fault.

At action 1004, participant ratings for each party to the transaction are determined. As described above with respect to FIGS. 2 and 6-9, these participant ratings may be determined prior to the dispute resolution request, or dynamically in response to receiving the request.

At action 1006, a dispute resolution plan may be recommended based on the ratings of the parties. For example, if the available data fails to indicate whether one party or the other is at fault, the method 1000 may recommend a decision in favor of the party with a higher overall rating, or a higher rating in a particular behavioral characteristic implicated in the dispute. For example, if the dispute is regarding a price discount level associated with a market share commitment level, and the buyer alleges that they met a market share commitment but failed to receive a commensurate discount but insufficient data exists to determine whether the buyer met that commitment (e.g., the buyer alleges transactions were performed outside the market platform), then a rating for the buyer's past compliance might be compared against a rating for the supplier's past history in offering correct discount levels. The party with the higher rating in that particular characteristic might be identified as entitled to a resolution in their favor.

FIG. 11 depicts a flow diagram illustrating an example method 1100 for identifying product backorders and attributing the backorders to appropriate parties. Delivery delays can be a frustrating experience for buyers, as contracts and market share commitments may require fulfillment from particular distributors or suppliers, reducing the ability of buyers to acquire needed supplies via other venues. As such, the market platform may reduce supplier or distributor ratings in response to detection of these occurrences to reflect the undesirable nature of delays. However, it may not always be readily apparent as to which party has caused the delay, and it may not be fair to reduce a distributor's rating if the distributor is only failing to ship the product due to a supply failure caused by the supplier.

As described above, the market platform may be employed to monitor transactions such as invoices, purchase orders, product shipments, shipments to suppliers, and the like. The method 1100 describes a process by which the market platform may leverage knowledge of these transactions to determine whether a product delay is due to the actions of a supplier or a distributor, and to properly adjust the ratings for the supplier or distributor based on which party is the cause of the delay. Embodiments of the method 1100 may be performed by an apparatus, such as the apparatus 102 described with respect to FIG. 1 or the market platform server 202 described with respect to FIG. 2.

At action 1102, the method 1100 receives transaction data. For example, the method may receive purchase order, invoice, and shipment data as described above with respect to the market platform. The method 1100 may identify dates and times of purchase orders and product shipments to ensure that ordered products are delivered in a timely manner.

At action 1104, the method 1100 identifies that there has been a failure by a distributor to deliver a product to a buyer. As described above, the failure to deliver may be identified by monitoring transactions performed using the market platform. For example, the market platform may identify that a particular time has elapsed since a buyer created a purchase order for a particular product without a corresponding delivery of the product, or the buyer may otherwise notify the market platform of a delay in receiving the product (e.g., via the buyer interface). Identification of the failure may trigger processing by the method 1100 to determine the source of the delay.

At action 1106, the method 1100 analyzes transaction data relating to the product to determine which party is responsible for the delay. For example, the market platform may examine shipments of other distributors of the same product to determine if the other distributors are still shipping the particular product. In the event that other distributors are also experiencing shipment delays for the same product, this may be indicative that the delay is attributable to a supplier. In contrast, if the other distributors of the product are continuing to ship the product, then it is more likely that the delay is attributable to the particular distributor. It should be appreciated that other methods of attributing the delay to the supplier or the distributor could also be employed using transaction data gathered by the market platform. For example, the analysis could include identifying whether the supplier has issued a product recall, or whether other buyers are experiencing shipment delays from other distributors.

At action 1108, the method 1100 determines whether the delay is attributable to the distributor or the supplier. If the delay is attributable to the supplier, the method 1100 proceeds to action 1110 where the rating for the supplier is adjusted to reflect that the supplier is the cause of the delay. Otherwise, the method 1100 proceeds to action 1112 where the rating for the distributor is adjusted to reflect that the distributor is the cause of the delay.

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 114 of an apparatus employing an embodiment of the present invention and executed by a processor 112 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

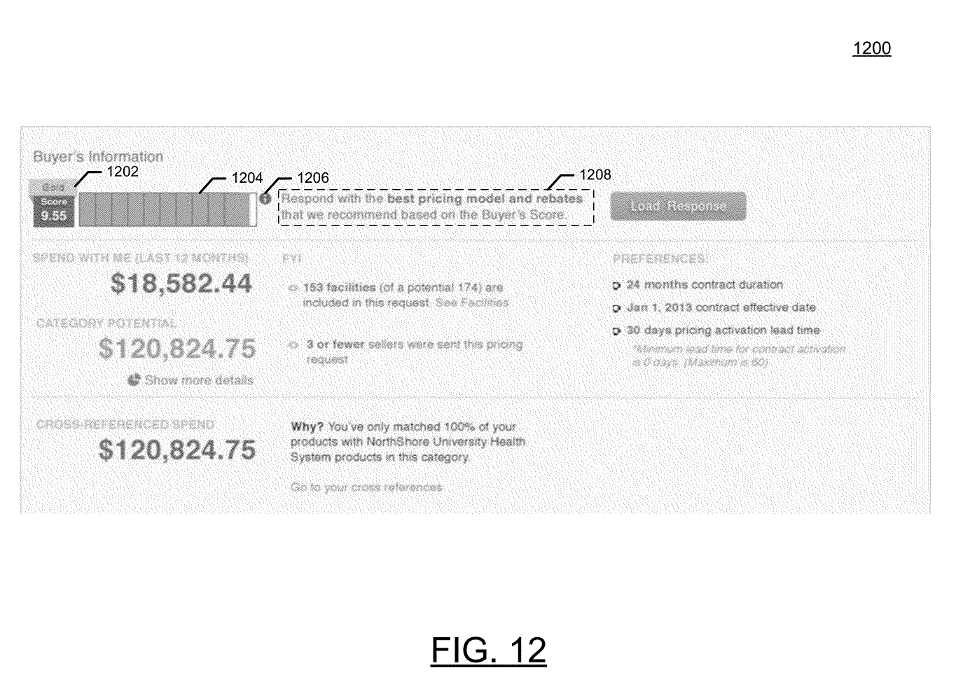

FIG. 12 depicts an illustration of an interface 1200 for viewing a participant rating in accordance with some example embodiments. The interface 1200 shows an example of a supplier's interface for responding to a buyer RFP. The interface 1200 includes a numerical rating display 1202 and a graphical rating display 1206 allowing the supplier to view the buyer's rating in a variety of formats. The numerical rating display 1202 shows a numerical representation of the buyer's rating. In this instance, the buyer has a rating of 9.95 out of 10, which is sufficient to earn the buyer a “Gold” status, reflecting that the buyer has very desirable characteristics for the seller (e.g., a high rate of meeting market share commitment goals, a high rate of CPA execution following RFPs, or the like). The graphical rating display 1204 provides a visual indication of the rating, showing that the rating is sufficient to nearly entirely fill a rating bar. The interface 1200 also includes an information icon 1206. The information icon 1206 may provide an interface control that, when selected by a user, displays a more detailed breakdown of the rating. For example, the information icon 1206 might display the factors that lead to the buyer's high rating (e.g., high history of compliance), or additional ratings used to determine the overall rating (e.g., separate ratings for sales volume, contract execution rate, and compliance).

The interface 1200 further provides an example recommendation 1208 based on the buyer compliance. In the present example, because the buyer has a high rating, the market platform recommends providing the buyer with a favorable price model to reflect the low risk of engaging in a contract with the buyer. As described above, the ratings may be used in a variety of manners, including automatically adjusting transactions based on ratings, recommending certain behaviors based on ratings (as in the present example interface 1200), or merely displaying the rating and allowing the user to decide how they wish to use the rating in their decision making process.

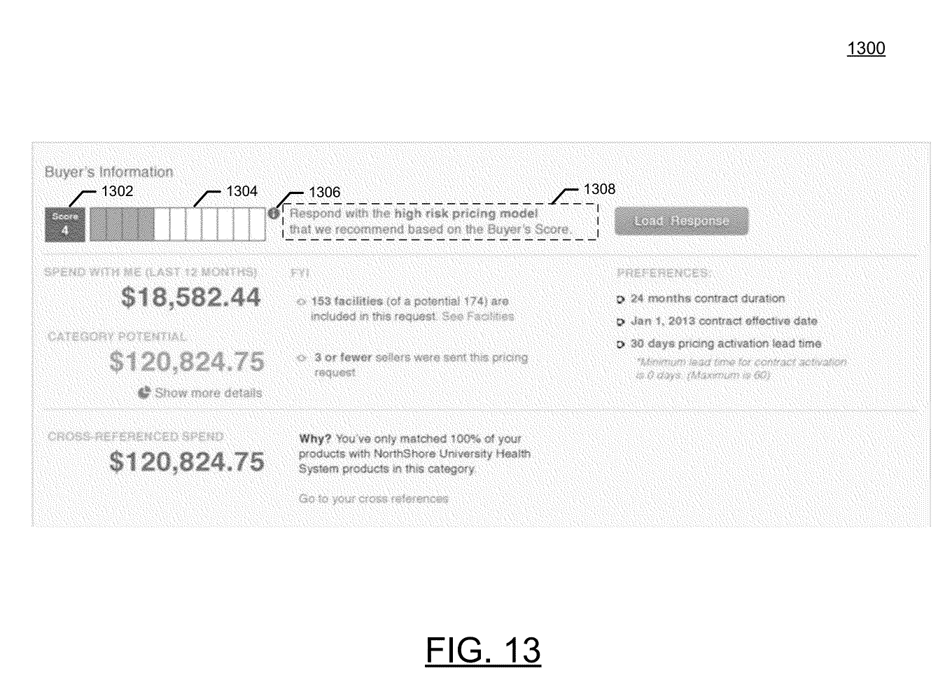

FIG. 13 depicts another interface 1300 for viewing a participant rating in accordance with some embodiments. As with the interface 1200, the interface 1300 depicts supplier a RFP response interface allowing the supplier to determine how to respond to an RFP for a buyer. In the example interface 1300, the buyer is associated with a low rating of 4 out of 10. As above, the interface 1300 depicts a numerical rating 1302 and a graphical rating 1304.

These ratings 1302, 1304 reflect the comparatively lower score assigned to the buyer. Notably, the numerical rating 1302 does not include a “Gold” icon, since the buyer does not have a particularly high rating. Similarly, selection of the information icon 1306 may provide the user with a detailed breakdown of the buyer's rating, which may reflect a history of compliance problems or failure to execute contracts in response to RFPs Likewise, the interface 1300 depicts a recommendation 1310 based on the buyer's rating which reflects the lower rating. The recommendation 1310 thus recommends responding to the buyer with a “high risk” pricing model (e.g., a pricing model that contains higher penalties for failure to meet market share commitments, or lower price discounts overall).

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving transaction data, the transaction data comprising data related to at least one transaction performed by a first participant using a market platform;
determining, using a processor, a rating for the first participant based on the transaction data, wherein the rating reflects one or more characteristics relating to the first participant's compliance with the terms of a committed pricing agreement generated by the market platform; and
providing the rating to a second participant to assist the second participant with performing a transaction with the first participant.

2. The method of claim 1, wherein the at least one transaction comprises at least one of a pricing response generated in response to a request for pricing, initiation of the request for pricing, generation of a purchase order, generation of an invoice, or shipment of a product.

3. The method of claim 1, further comprising receiving a set of rating parameters from the second participant, and wherein the rating is determined using the set of rating parameters.

4. The method of claim 1, wherein the second participant is a buyer, and wherein the method further comprises:
removing the first participant from a list of suppliers in response to the rating being below a threshold value.

5. The method of claim 1, wherein the second participant is a supplier, and wherein the method further comprises:
selecting a price model from a plurality of price models to provide in response to a request from pricing initiated by the first participant, the price model selected based on the rating.

6. The method of claim 5, wherein the selected price model offers a price model with a greater value to the first participant if the first participant's rating exceeds a threshold rating than if the first participant's rating fails to exceed the threshold rating.

7. The method of claim 1, wherein determining the rating further comprises determining a ratio of total requests for pricing initiated by the first participant to requests for pricing initiated by the first participant that lead to an executed committed pricing agreement.

8. The method of claim 1, wherein determining the rating further comprises determining a frequency with which the first participant offered a reimbursement to a buyer in response to the buyer exceeding a particular compliance threshold.

9. An apparatus comprising at least one processor and at least one memory, the memory comprising instructions that, when executed by a processor, configure the apparatus to:
receive transaction data, the transaction data comprising data related to at least one transaction performed by a first participant using a market platform;
determine a rating for the first participant based on the transaction data, wherein the rating reflects one or more characteristics relating to the first participant's compliance with the terms of a committed pricing agreement generated by the market platform; and
provide the rating to a second participant to assist the second participant with performing a transaction with the first participant.

10. The apparatus of claim 9, wherein the at least one transaction comprises at least one of a pricing response generated in response to a request for pricing, initiation of the request for pricing, generation of a purchase order, generation of an invoice, or shipment of a product.

11. The apparatus of claim 9, wherein the processor is further configured to receive a set of rating parameters from the second participant, and wherein the rating is determined using the set of rating parameters.

12. The apparatus of claim 9, wherein the second participant is a buyer, and wherein the processor is further configured to remove the first participant from a list of suppliers in response to the rating being below a threshold value.

13. The apparatus of claim 9, wherein the second participant is a supplier, and wherein the processor is further configured to select a price model from a plurality of price models to provide in response to a request from pricing initiated by the first participant, the price model selected based on the rating.

14. The apparatus of claim 13, wherein the selected price model offers a price model with a greater value to the first participant if the first participant's rating exceeds a threshold rating than if the first participant's rating fails to exceed the threshold rating.

15. The apparatus of claim 9, wherein the processor is further configured to determine the rating by at least determining a ratio of total requests for pricing initiated by the first participant to requests for pricing initiated by the first participant that lead to an executed committed pricing agreement.

16. The apparatus of claim 9, wherein the processor is further configured to determine the rating by at least determining a frequency with which the first participant offered a reimbursement to a buyer in response to the buyer exceeding a particular compliance threshold.

17. A computer program product comprising a non-transitory computer readable storage medium, the non-transitory computer readable storage medium comprising instructions that, when executed by a processor, configure the processor to:
receive transaction data, the transaction data comprising data related to at least one transaction performed by a first participant using a market platform;
determine a rating for the first participant based on the transaction data, wherein the rating reflects one or more characteristics relating to the first participant's compliance with the terms of a committed pricing agreement generated by the market platform; and
provide the rating to a second participant to assist the second participant with performing a transaction with the first participant.

18. The computer program product of claim 17, wherein the at least one transaction comprises at least one of a pricing response generated in response to a request for pricing, initiation of the request for pricing, generation of a purchase order, generation of an invoice, or shipment of a product.

19. The computer program product of claim 17, further comprising instructions to configure the processor to receive a set of rating parameters from the second participant, and wherein the rating is determined using the set of rating parameters.

20. The computer program product of claim 17, wherein the second participant is a buyer, and wherein the computer program product further comprises instructions to configure the processor to remove the first participant from a list of suppliers in response to the rating being below a threshold value.
